(19) United States
(12) Patent Application Publication
(10) Pub. No.: US 2026/0006642 A1
(43) Pub. Date: Jan. 1, 2026

(54) METHOD OF CONTENTION RESOLUTION FOR PREDICTIVE CONTENTION

(71) Applicant: BAE Systems Information and Electronic Systems Integration Inc., Nashua, NH (US)

(72) Inventor: Matthew J. Sherman, Succasunna, NJ (US)

(73) Assignee: BAE Systems Information and Electronic Systems Integration Inc., Nashua, NH (US)

(21) Appl. No.: 18/755,038

(22) Filed: Jun. 26, 2024

(51) Int. Cl. H04W 74/0816

(52) U.S. Cl. CPC H04W 74/0816

(57) ABSTRACT

A transmission system that includes an initiator, a responder, and a computer program product. The initiator includes a first processor and a first computer readable medium that is accessible by the first processor. The responder includes a second processor and a second computer readable medium accessible by the second processor, wherein the responder is operatively in communication with the initiator. The computer program product is stored on the first computer readable medium and on the second computer readable medium. When the computer program product is executed by the first processor of the initiator and the second processor of the responder, the computer program product establishes a contention free schedule between the initiator and the responder to communicate at predetermined time periods.

### RELATED APPLICATIONS

Initially, it is noted that the present disclosure is related to the below listed U.S. Patent applications (“the Incorporated Applications”), filed on equal date herewith, the entirety of each of which is incorporated herein as if fully rewritten. The Incorporated Applications are:
1. U.S. patent application Ser. No. ______, entitled “METHOD FOR PREDICTIVE CONTENTION”, having the Attorney Docket Number: 23-BAE-0434; and
2. U.S. patent application Ser. No. ______, entitled “METHOD FOR CONTROL OF PREDICTIVE CONTENTION”, having the Attorney Docket Number: 23-BAE-0445.
   Since the present disclosure is related to the Incorporated Applications, some similar structural nomenclature is used herein when referencing some portions of the present disclosure relative to the Incorporated Applications. However, there may be some instances where structural nomenclature differs between similar elements and there may be other instances where nomenclature is similar between distinct elements relative to the present disclosure and the Incorporated Applications. Further, there may be instances in this disclosure that utilize similar reference numerals when referencing some portions or components of the present disclosure and its associated method(s) as in the Incorporated Applications. However, there may also be instances where (i) different reference numerals are utilized herein to refer to similar components as in the Incorporated Applications and/or (ii) similar reference numerals are utilized herein to refer to different components from the Incorporated Applications.

### TECHNICAL FIELD

The present disclosure generally relates to transmission schedules between nodes in a network, specifically a practical application or program to resolve transmission contention in transmission schedules using omnidirectional or directional antennas in a network.

### BACKGROUND ART

Directional networks provide significant promise for future high-bandwidth communications architectures. There is an increasing need for the capacity to support multi-media and other bandwidth-intensive applications while spectrum availability is decreasing. Directional networks allow for high capacity communications by focusing the energy between transmitter and receiver and providing greater frequency reuse. These networks can either be radio frequency (RF) or optical (free-space optical communications).

Currently, directional networks utilize transmission and reception schedules in which a transmitter transmits a signal to a receiver during a time slot. The transmitter transmits the signal during the time slot and the receiver “listens” for the signal during the time slot. Each of these respective actions occur during one time period or time slot.

The transmission and reception schedules between two network devices (e.g., transmitter and receiver) must be determined so the transmitter and receiver are directed at one another to communicate. However, current communication schedules used between two network devices simply set periods where a first network device will transmit or “talk” while a second network device will receive or “listen” to the first network device. While such scheduling is suitable, the two network devices may have communication contention or issues between one another due to one or both of the network devices having one or more separate communication schedules with separate network devices at the same transmission times. With such contention, communication between these two network devices becomes delayed thus creating a lag in communication between these two network devices and other separate network devices. Such a situation may also result in lost packets which can greatly impact overall network performance.

### SUMMARY OF THE INVENTION

Thus, a need continues to exist for an improved scheduling application or product for directional networks to more efficiently resolve contention between two or more network devices. The present disclosure improves resolution efficiency by providing a contention free schedule application or program that schedules signal transmissions and signal receptions between two or more network devices prior to the two or more network devices initiating transmission signals. The present disclosure also improves resolution efficiency by providing a predictive contention application or program that sets the number of available transmission slots and available reception slots for each network device prior to the two or more network devices initiating transmission signals. The present disclosure also improves resolution efficiency by providing a predictive contention control application or program that sets the number of available transmission slots and available reception slots for each network device and transmission or reception offsets prior to the two or more network devices initiating transmission signals. The embodiments discussed in the present disclosure are also improvements to network management systems or systems of the like and are directed towards specific implementations of a solution to a network scheduling problem in the software arts.

In one aspect, an exemplary embodiment of the present disclosure may provide a computer program product including one or more non-transitory machine-readable mediums encoded with instructions that, when executed by one or more processors of a set of network devices of a transmission system, cause a process to establish a resolution schedule subsequent to a discovery operation. The instructions comprising: execute, by a first processor of the at least two processors of an initiator of the set of network devices, a set of initiation instructions that instructs the initiator to output an initiation message including at least a set of initiator transmission opportunities having a first scope upon receiving a contention variable from a responder of the network device; execute, by a second processor of the at least two processors of the responder of the set of network devices, a set of response instructions that instructs the responder to select a set of responder response opportunities upon receiving the set of initiator transmission opportunities and to output a response message that includes at least a set of responder transmission opportunities having a second scope; and execute, by the first processor of the initiator, a set of confirmation instructions that instructs the initiator to select a set of initiator response opportunities upon receiving the set of responder transmission opportunities and to output a confirmation message that includes the set of initiator response opportunities.

This exemplary embodiment or another exemplary embodiment may further include steps to execute, by the first processor of the initiator of the set of network devices, a set of first maintenance instructions that instructs the initiator to output a first maintenance message including a second set of initiator transmission opportunities having a third scope that is greater than the first scope; and execute, by the second processor of the responder of the set of network devices, a set of second maintenance instructions that instructs the responder to select a second set of responder response opportunities upon receiving the second set of initiator transmission opportunities and to output a second maintenance message that includes a second set of responder transmission opportunities having a fourth scope that is greater than the second scope and is equal with or different than the third scope. This exemplary embodiment or another exemplary embodiment may further include a step to execute, by the first processor of the initiator of the set of network devices, a termination method that instructs the initiator to output a termination message to the responder to terminate communication between the initiator and the responder. This exemplary embodiment or another exemplary embodiment may further include that the step to execute the set of initiation instructions by the first processor of the initiator further comprises: execute, by the first processor of the initiator of the set of network devices, a puncturing step that instructs the initiator to transmit a punctured message to the responder to provide communication between the initiator and the responder. This exemplary embodiment or another exemplary embodiment may further include a step to execute, by the second processor of the responder of the set of network devices, a termination step that instructs the responder to transmit a termination message to a preexisting network device to terminate communication between the responder and the preexisting network device at at least one response opportunities of the set of responder response opportunities. This exemplary embodiment or another exemplary embodiment may further include that the first scope and the second scope are different from one another. This exemplary embodiment or another exemplary embodiment may further include a step to execute, by the first processor of the initiator, at least one initiator back-off step that instructs the first processor of the initiator to refrain from selecting one or more transmission opportunities from the set of initiator transmission opportunities or one or more receive opportunities from the set of initiator response opportunities. This exemplary embodiment or another exemplary embodiment may further include a step to execute, by the second processor of the responder, at least one responder back-off step that instructs the second processor of the responder to refrain from selecting one or more transmission opportunities from the set of responder transmission opportunities or one or more receive opportunities from the set of responder response opportunities. This exemplary embodiment or another exemplary embodiment may further include that the steps of the initiator to output the initiation message and the confirmation message further includes: output the initiation message and the confirmation message in a first signal direction; and wherein the step of the responder to output the response message further includes: output the response message in a second signal direction; wherein the initiator and the responder are directional antennas such that the first signal direction and the second signal direction are concentrated in a single direction. This exemplary embodiment or another exemplary embodiment may further include that the steps to output the initiation message and the confirmation message by the initiator further includes: output the initiation message and the confirmation message in a plurality of first signal directions; and wherein the step to output the response message by the responder further includes: output the response message in a second signal direction; wherein each of the initiator and the responder is an omnidirectional antenna.

In another aspect, another exemplary embodiment of the present disclosure may provide a method of establishing a contention free schedule in a transmission system. The method comprising steps of: installing a computer program product with a set of network devices of the transmission system, the transmission system comprises at least: an initiator of the set of network devices of the transmission system having a first processor; and a responder of the set of network devices of the transmission system having a second processor that is operatively in communication with the initiator; wherein when the computer program product is executed by the first processor of the initiator and the second processor of the responder, the first processor and the second processor are caused to: output an initiation message including at least a set of initiator transmission opportunities having a first scope upon receiving a contention variable from the responder of the set of network devices; select a set of responder response opportunities upon receiving the set of initiator transmission opportunities and to output a response message that includes at least a set of responder transmission opportunities having a second scope that is equal with or different than the first scope; select a set of initiator response opportunities upon receiving the set of responder transmission opportunities and to output a confirmation message that includes the set of initiator response opportunities; and establish the contention free schedule in the transmission system between the initiator and the responder for communicating at predetermined time periods.

This exemplary embodiment or another exemplary embodiment may further include that when the computer program product is executed by the first processor of the initiator and the second processor of the responder, the first processor and the second processor are further caused to: output a first maintenance message including a second set of initiator transmission opportunities having a third scope that is greater than the first scope; and select a second set of responder response opportunities upon receiving the second set of initiator transmission opportunities and to output a second maintenance message that includes a second set of responder transmission opportunities having a fourth scope that is greater than the second scope and is equal with or different than the third scope. This exemplary embodiment or another exemplary embodiment may further include that when the computer program product is executed by the first processor of the initiator and the second processor of the responder, the first processor and the second processor are further caused to: output a termination message to the responder to terminate communication between the initiator and the responder. This exemplary embodiment or another exemplary embodiment may further include that when the computer program product is executed by the first processor of the initiator and the second processor of the responder, the first processor is further caused to: transmit a punctured message to the responder to provide communication between the initiator and the responder. This exemplary embodiment or another exemplary embodiment may further include that when the computer program product is executed by the first processor of the initiator and the second processor of the responder, the second processor is further caused to: transmit a termination message to a preexisting network device to terminate communication between the responder and the preexisting network device at at least one response opportunities of the set of responder response opportunities. This exemplary embodiment or another exemplary embodiment may further include that when the computer program product is executed by the first processor of the initiator and the second processor of the responder, the first processor is further caused to: refrain from selecting one or more transmission opportunities from the set of initiator transmission opportunities or one or more receive opportunities from the set of initiator response opportunities. This exemplary embodiment or another exemplary embodiment may further include that when the computer program product is executed by the first processor of the initiator and the second processor of the responder, the second processor is further caused to: refrain from selecting one or more transmission opportunities from the set of responder transmission opportunities or one or more receive opportunities from the set of responder response opportunities. This exemplary embodiment or another exemplary embodiment may further include that the steps to output the initiation message and the confirmation message by the initiator further includes: output the initiation message and the confirmation message in a first signal direction; and wherein the step of the responder to output the response message by the responder further includes: output the response message in a second signal direction; wherein the initiator and the responder are directional antennas such that the first signal direction and the second signal direction are concentrated in a single direction. This exemplary embodiment or another exemplary embodiment may further include that the steps to output the initiation message and the confirmation message by the initiator further includes: output the initiation message and the confirmation message in a plurality of first signal directions; and wherein the step of the responder to output the response message by the responder further includes: output the response message in a second signal direction; wherein the initiator and the responder are omnidirectional antennas.

In another aspect, another exemplary embodiment of the present disclosure may provide a transmission system. The transmission system includes an initiator having a first processor and a first computer readable medium accessible by the first processor; a responder having a second processor and a second computer readable medium accessible by the second processor, wherein the responder is operatively in communication with the initiator; and a computer program product that is stored on the first computer readable medium and is stored on the second computer readable medium; wherein when the computer program product is executed by the first processor of the initiator and the second processor of the responder, the computer program product establishes a contention free schedule between the initiator and the responder to communicate at predetermined time periods.

In yet another aspect, another exemplary embodiment of the present disclosure may provide a method. The method comprises steps of: installing a computer program product with a set of network devices of a transmission system, wherein each network device of the set of network devices of the transmission system comprises at least: a processor; and a computer readable medium that is accessible by the processor and stores the computer program product having a predictive contention program and a control program; wherein when the computer program product is executed by the processor of each network device of the set of network devices of the transmission system, each processor is caused to: input a set of contention parameters for at least one set of communication time intervals; input a set of offset parameters for the at least one set of communication time intervals; select whether at least one set of communication time intervals is set to a transmission state or a reception state; generate a number of communication time intervals that defines the at least one set of communication time intervals set at the transmission state or the reception state; apply a time offset to each communication time interval of the at least one set of communication time intervals; and generate a schedule with the at least one set of communication time intervals set at the transmission state or the reception state.

This exemplary embodiment or another exemplary embodiment may further include that when the selected communication time intervals are set to the transmission state, the computer program product further comprises: select at least another set of communication time intervals for the reception state; generate a number of communication time intervals that sets the at least another set of communication time intervals to the reception state; and integrate the at least another set of communication time intervals set at the reception state into the schedule. This exemplary embodiment or another exemplary embodiment may further include that when the selected communication time intervals are set to the reception state, the computer program product further comprises: select at least another set of communication time intervals for the transmission state; generate a number of communication time intervals that sets the at least another set of communication time intervals to the transmission state; and integrate the at least another set of communication time intervals set at the transmission state into the schedule. This exemplary embodiment or another exemplary embodiment may further include that when the processor of each network device inputs the set of contention parameters, the processor is further caused to: input a minimum number of transmit time intervals; and input a minimum number of reception time intervals. This exemplary embodiment or another exemplary embodiment may further include that when the processor of each network device inputs the set of contention parameters, the processor is further caused to: input a maximum variance allowed number of transmit time intervals; and input a maximum variance allowed number of reception time intervals. This exemplary embodiment or another exemplary embodiment may further include that when the processor of each network device inputs the set of contention parameters, the processor is further caused to: generate a schedule size. This exemplary embodiment or another exemplary embodiment may further include that when the processor of each network device inputs the set of contention parameters, the processor is further caused to: generate a seed for an assigned period of time; wherein the seed include at least a common key and a node identifier. This exemplary embodiment or another exemplary embodiment may further include that when the processor of each network device inputs the set of contention parameters, the processor is further caused to: set the seed. This exemplary embodiment or another exemplary embodiment may further include that the step to input the set of offset parameters further comprises: input transmission start offsets for the set of offset input parameters; and input transmission end offsets for the set of offset input parameters. This exemplary embodiment or another exemplary embodiment may further include that the step to input the set of offset parameters further comprises: input reception start offsets for the set of offset input parameters; and input reception end offsets for the set of offset input parameters.

In yet another aspect, another exemplary embodiment of the present disclosure may provide a method. The method comprises steps of installing a computer program product with a set of network devices of a transmission system, wherein each network device of the set of network devices of the transmission system comprises at least: a processor; and a computer readable medium that is accessible by the processor and stores the computer program product having a predictive contention program and a contention resolution program; wherein when the computer program product is executed by the processor of each network device of the set of network devices of the transmission system, each processor is caused to: generate a schedule with the at least one set of communication time intervals; output an initiation message including at least a set of initiator transmission opportunities having a first scope upon receiving a contention variable from the responder of the set of network devices; select a set of responder response opportunities upon receiving the set of initiator transmission opportunities and to output a response message that includes at least a set of responder transmission opportunities having a second scope that is equal with or different than the first scope; select a set of initiator response opportunities upon receiving the set of responder transmission opportunities and to output a confirmation message that includes the set of initiator response opportunities; and establish the contention free schedule between the initiator and the responder for communicating at predetermined time periods.

This exemplary embodiment or another exemplary embodiment may further include that when the computer program product is executed by the processor of each network device of the set of network devices of the transmission system, each processor is further caused to: input a set of contention parameters for at least one set of communication time intervals; select whether at least one set of communication time intervals is set to a transmission state or a reception state; generate a number of communication time intervals that defines the at least one set of communication time intervals set at the transmission state or the reception state; and generate a schedule with the at least one set of communication time intervals set at the transmission state or the reception state. This exemplary embodiment or another exemplary embodiment may further include when the selected communication time intervals are set to the transmission state, the computer program product further comprises: select at least another set of communication time intervals for the reception state; generate a number of communication time intervals that sets the at least another set of communication time intervals to the reception state; and integrate the at least another set of communication time intervals set at the reception state into the schedule. This exemplary embodiment or another exemplary embodiment may further include when the selected communication time intervals are set to the reception state, the computer program product further comprises: select at least another set of communication time intervals for the transmission state; generate a number of communication time intervals that sets the at least another set of communication time intervals to the transmission state; and integrate the at least another set of communication time intervals set at the transmission state into the schedule. This exemplary embodiment or another exemplary embodiment may further include that when the processor of each network device inputs the set of contention parameters, the processor is further caused to: input a minimum number of transmit time intervals; input a minimum number of reception time intervals; input a maximum variance allowed number of transmit time intervals; and input a maximum variance allowed number of reception time intervals. This exemplary embodiment or another exemplary embodiment may further include steps to output a first maintenance message including a second set of initiator transmission opportunities having a third scope that is greater than the first scope; and select a second set of responder response opportunities upon receiving the second set of initiator transmission opportunities and to output a second maintenance message that includes a second set of responder transmission opportunities having a fourth scope that is greater than the second scope and is equal with or different than the third scope. This exemplary embodiment or another exemplary embodiment may further include a step to output a termination message to the responder to terminate communication between the initiator and the responder. This exemplary embodiment or another exemplary embodiment may further include a step to output a punctured message to the responder to provide communication between the initiator and the responder. This exemplary embodiment or another exemplary embodiment may further include as step to output a termination message to a preexisting network device to terminate communication between the responder and the preexisting network device at at least one response opportunities of the set of responder response opportunities.

In yet another aspect, another exemplary embodiment of the present disclosure may provide a transmission system having at least two network devices that are operable with one another. Each network device of the at least two network devices comprising: a processor a computer program product stored on a computer readable medium and executable by the processor of each of the initiator and the responder, the computer program product comprising: a predictive contention program executable by the processor to generate a schedule with a first set of communication time intervals set at a transmit state and a second set of communication time intervals set at a receive state; a contention resolution program executable by the processor to establish a contention free schedule between the at least two network devices of transmission system; and a control program executable by the processor to offset at least one communication time interval.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a diagrammatic view of a transmission system having a set of network devices, wherein at least two network devices of the set of network devices are communication with one another.

FIG. 2A (FIG. 2A) is another diagrammatic view similar to FIG. 1, wherein the at least two network devices of the set of network devices are directed at one another and are communicating with one another, wherein the network devices include directional antennas.

FIG. 2B (FIG. 2B) is another diagrammatic view similar to FIG. 1, wherein the at least two network devices of the set of network devices are directed at a central network device and are communicating with one another, wherein the at least two network devices and the central network device includes an omnidirectional antenna.

FIG. 3A (FIG. 3A) is a diagrammatic block diagram of a predictive contention program that is accessible and executable by the set of network devices.

FIG. 3B (FIG. 3B) is a diagrammatic flowchart of the predictive contention method of the predictive contention program.

FIG. 4 (FIG. 4) is an operational view of the network devices executing the predictive contention program to generate a schedule having sets of time intervals to transmit messages and to receive messages.

FIG. 5 (FIG. 5) is a diagrammatic flowchart of an initiation method of a contention free schedule program that is accessible and executable by the set of network devices.

FIG. 6 (FIG. 6) is a diagrammatic process diagram of the initiation method of the contention free schedule program being executed by an initiator of the set of network devices and a responder of the set of network devices.

FIG. 7 (FIG. 7) is a diagrammatic flowchart of a maintenance method of the contention free schedule program that is accessible and executable by the set of network devices.

FIG. 8 (FIG. 8) is a diagrammatic process diagram of the maintenance method of the contention free schedule program being executed by the initiator and the responder subsequent to the initiation method.

FIG. 9 (FIG. 9) is a diagrammatic flowchart of a termination method of the contention free schedule program that is accessible and executable by the set of network devices.

FIG. 10 (FIG. 10) is a diagrammatic process diagram of the termination method of the contention free schedule program being executed by the initiator and the responder subsequent to the initiation method and/or the maintenance method.

FIG. 11A (FIG. 11A) is an operational view of the initiator executing a set of initiation instructions of the initiation method of the contention free schedule program subsequent to performing a discovery method, wherein the initiator executes a puncturing step to establish communication with the responder.

FIG. 11B (FIG. 11B) is an enlargement of the highlighted region shown in FIG. 11A.

FIG. 11C (FIG. 11C) is another operational view similar to FIG. 11A, but the responder executes a set of response instructions of the initiation method of the contention free schedule program.

FIG. 11D (FIG. 11D) is another operational view similar to FIG. 11A, but the initiator executes a set of confirmation instructions of the initiation method of the contention free schedule program to establish a contention free schedule between the initiator and the responder.

FIG. 12 (FIG. 12) is a diagrammatic block diagram of a predictive contention control program that is accessible and executable by the set of network devices.

FIG. 13A (FIG. 13A) is a diagrammatic process diagram of the initiation method of the contention free schedule program and the predictive contention control program being executed by the initiator of the set of network devices and the responder of the set of network devices.

FIG. 13B (FIG. 13B) is a diagrammatic process diagram of an updated predictive contention control program being executed by the initiator of the set of network devices.

FIG. 13C (FIG. 13C) is a diagrammatic process diagram of a timeout traffic method of the predictive contention control program being executed by the initiator of the set of network devices.

FIG. 14A (FIG. 14A) is an operational view of network devices executing the predictive contention program and the predictive contention control program.

FIG. 14B (FIG. 14B) is another operational view similar to FIG. 14A, but the network devices execute the contention free schedule program subsequent to and/or concurrently with executing the predictive contention program and the predictive contention control program.

Similar numbers refer to similar parts throughout the drawings.

### DETAILED DESCRIPTION

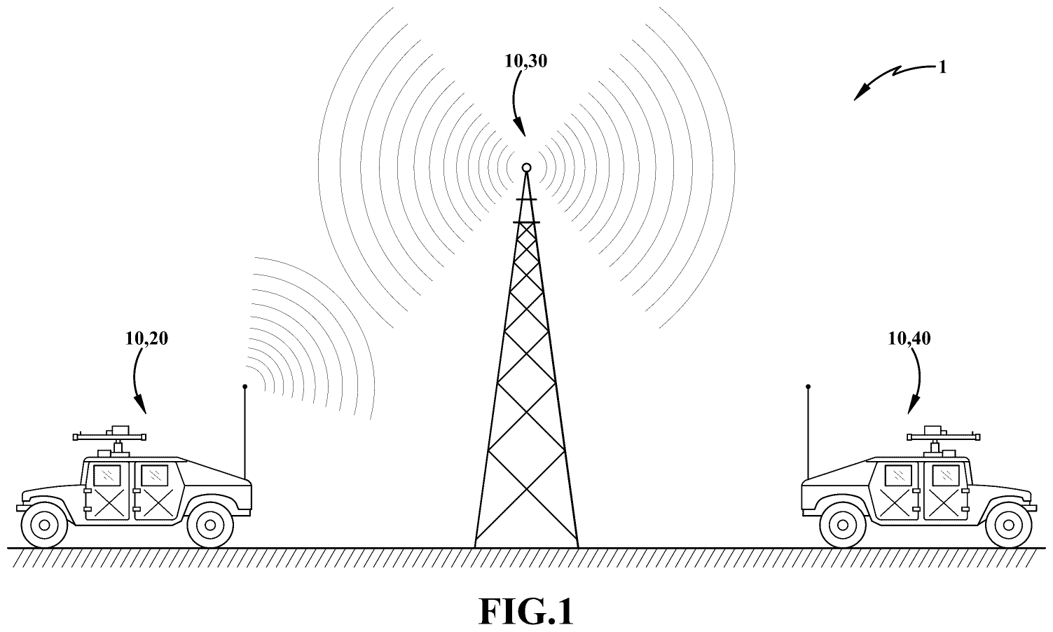

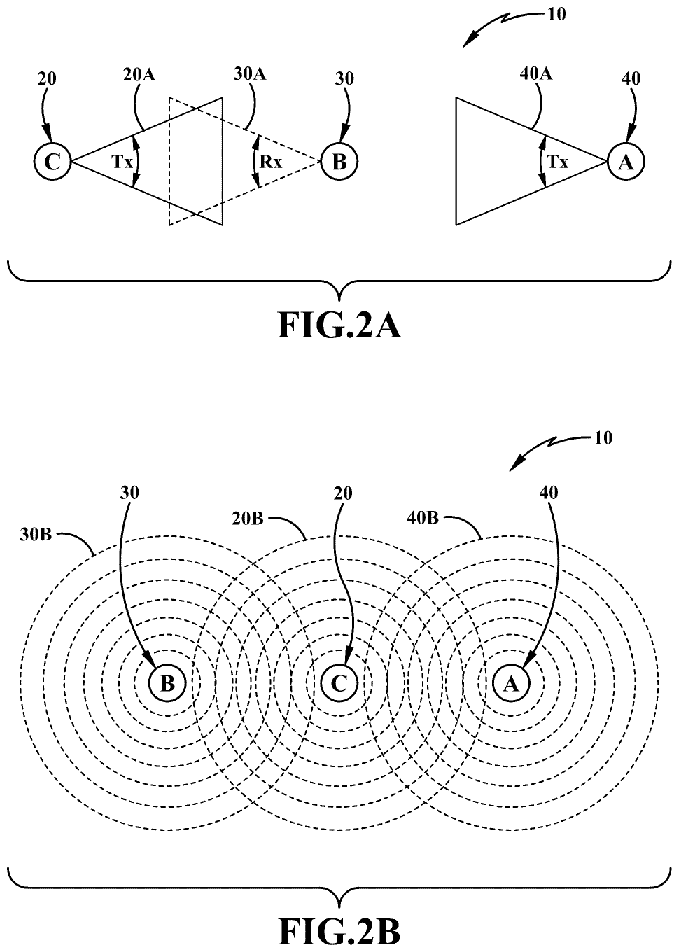

FIGS. 1-2A illustrate a directional networking system or transmission system 1 that is made up by a set of network devices 10. In the present disclosure, the transmission system 1 may generally include at least one initiator or first network device 20 of the set of network devices 10, at least one responder or second network device 30 of the set of network devices 10, and a plurality of preexisting devices 40. As discussed in greater detail below, each of the initiator 20 and the responder 30 is loaded with computer program products that predict, resolve, and control transmission contentions and reception contentions between the initiator 20 and responder 30 when the initiator 20 and responder 30 are directed at and interfere with one another.

It should be understood that the network devices of the set of network devices 10 may include any suitable antennas for the transmission system 1. In one exemplary embodiment, and as best seen in FIG. 2A, the initiator 20, the responder 30, and the preexisting device 40 include directional antennas shown from a two-dimensional top plan view. In this exemplary embodiment, the initiator 20 emits a transmission signal within a transmitting angle transmit (Tx) (beam) 20A while the responder 30 receives signals within a receiving angle (beam) 30A. It should be noted that the initiator 20 and the responder 30 can only transmit or receive signals within a limited set of directions at a given time (termed a beam) to interoperate with one another. While the preexisting device 40 is also shown emitting a transmission signal on beam 40A within a transmitting angle Tx, preexisting device 40 may also be set to receive information similar to the configuration of responder 30.

In another exemplary embodiment, and as best seen in FIG. 2B, the initiator 20 includes an omnidirectional antenna while the responder 30 and the preexisting device 40 also include omnidirectional antennas shown from a two-dimensional top plan view. In this exemplary embodiment, the initiator 20 emits a transmission signal 20B with an omnidirectional beam with transmitting angle Tx including all directions receivable by responder 30 which receives the signal within a receiving beam 30B and the preexisting device 40 is shown as receiving signal 20B within receiving beam 40B. It should be noted that the initiator 20 emits the transmission signal 20B in more than one signal direction and/or in a plurality of signal directions given the initiator 20 is shown as an omnidirectional antenna while receiver beams 30B, 40B of the responder 30 and the preexisting device 40 can also be directed and/or concentrated in a plurality of signal directions. In this exemplary embodiment, the initiator 20 may also receive one or more signals in multiple directions from the responder 30 and preexisting devices 40. In both exemplary embodiments, the computer program products mentioned herein may be used in both situations and similar transmission or reception situations of the like.

It should be understood that while the network devices 10 are illustrated as military vehicles and/or platforms, such illustration should not limit and/or hinder the use of the technology discussed herein. In one exemplary embodiment, the network devices 10 (as well as the computer program products discussed herein) may be used in a civilian and/or commercial setting for wireless transmission purposes such as a wireless LAN or cellular network. In yet another exemplary embodiment, the network devices 10 (as well as the computer program products discussed herein) may be used in civilian and/or commercially available vehicles or mobile platforms for wireless transmission purposes.

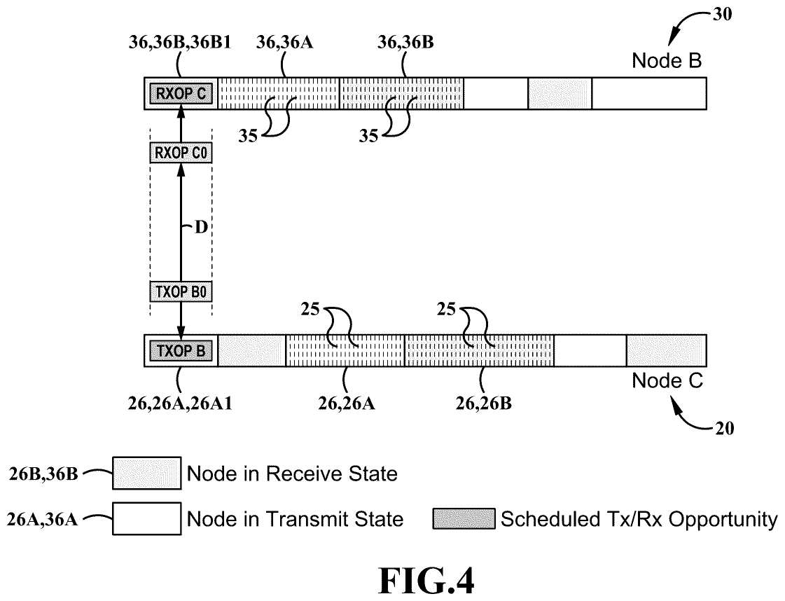

With respect to the initiator 20, the initiator 20 includes a processor 22. As best seen in FIG. 4, the processor 22 is illustrated herein for schematic and diagrammatic purposes. In other exemplary embodiments, any suitable number of processors may be provided with an initiator and/or first network device for a specific operation. Processor 22 is configured to logically perform applications or computer program products that the processor 22 has access to prior to operation, including a predictive contention program 50 that is discussed in greater detail below. The processor 22 may also be powered by an on-board power source and/or power supply (e.g., portable battery, etc.) in order to logically perform applications or computer program products that are operatively in communication with the processor 22. The processor 22 may also be in logical communication with a tangible medium, such as a non-transitory computer readable medium, for executing predictive contention program 50 and other computer program products discussed herein.

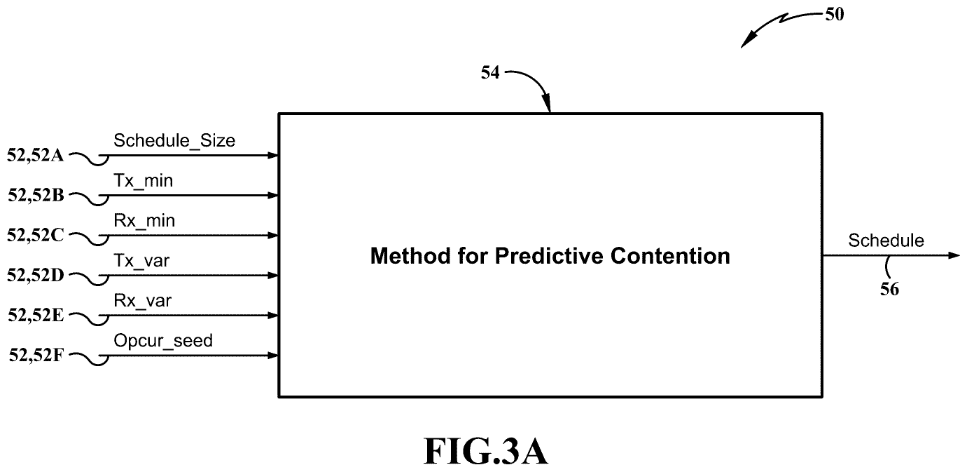

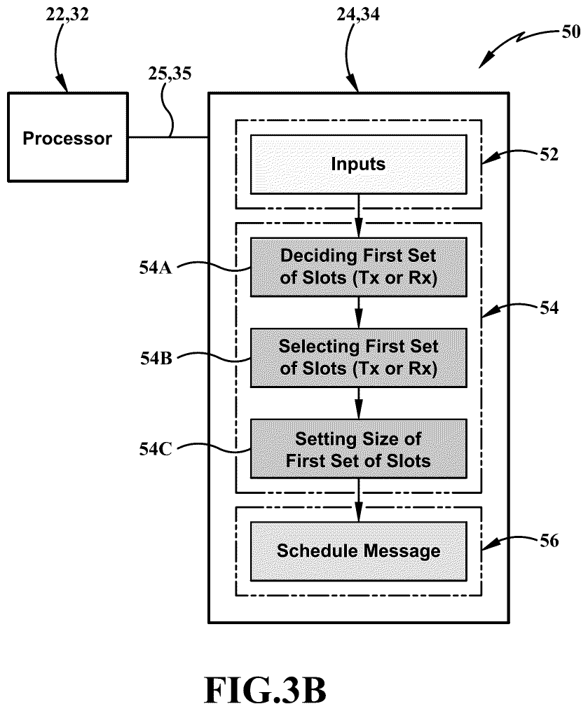

Initiator 20 also includes at least one non-transitory computer readable medium 24 (see FIG. 3B). In the present disclosure, a single computer readable medium 24 is illustrated herein for schematic and diagrammatic purposes. In other exemplary embodiments, any suitable number of computer readable media may be provided with an initiator and/or first network device for a specific operation. Computer readable medium 24 is configured to logically store applications or computer program products that the processor 22 has access to prior to execution, such as predictive contention program 50 and other computer program products discussed herein. Computer readable medium 24 may also be powered by an on-board power source and/or power supply (e.g., portable battery, etc.) in order to be operatively in communication with the processor 22.

In the present disclosure, the computer readable storage medium 24 is operatively connected with the processor 22 via an electrical connection as diagrammatically illustrated, such as wire or other similar electrical connection of the like. As best seen in FIG. 3B, the computer readable medium 24 operatively connects with processor 22 by a first electrical connection 23. With such an electrical connection, by the first electrical connection 23, the processor 22 and the computer readable medium 24 are enabled to communicate with one another during operation. As discussed in greater detail below, processor 22 may access and execute the predictive contention program 50 that is stored in the computer readable medium 24 to resolve and/or predict communication contention between the initiator 20 and another network device, such as responder 30, when transmitting and receiving information between one another.

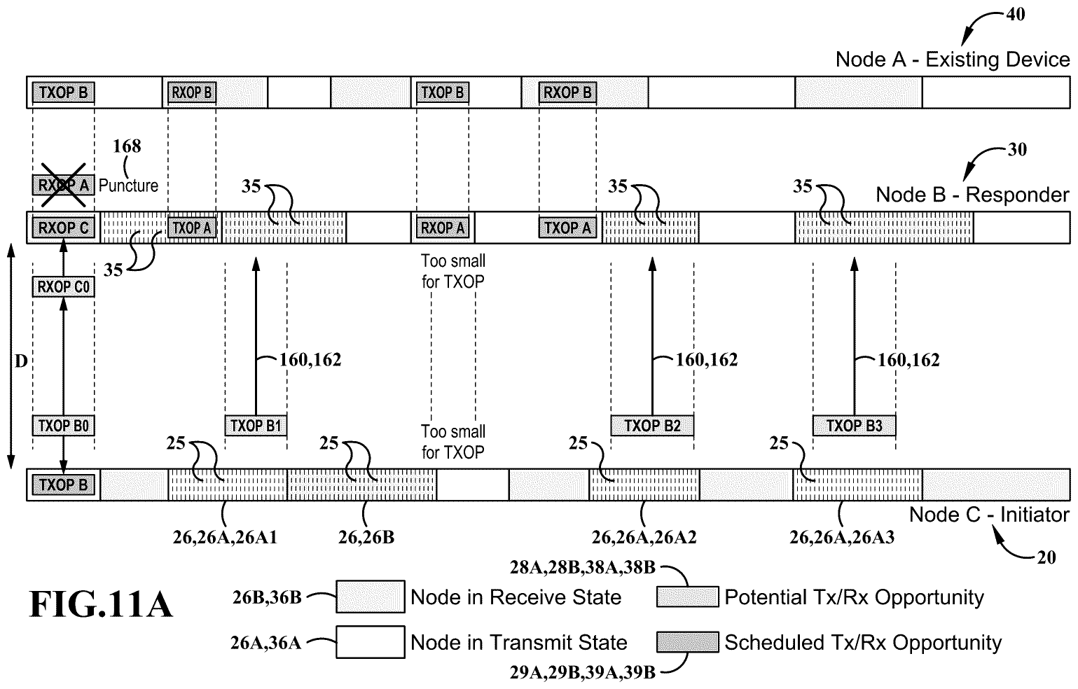

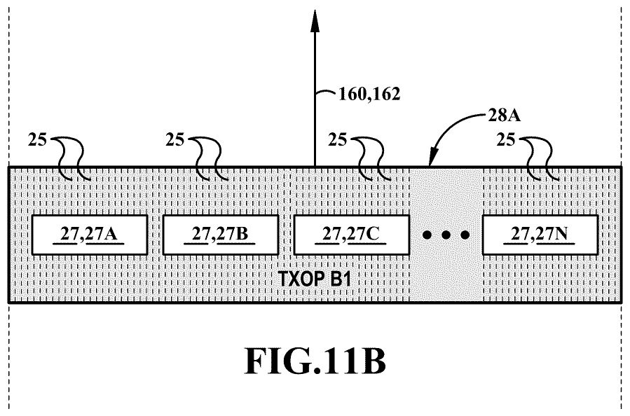

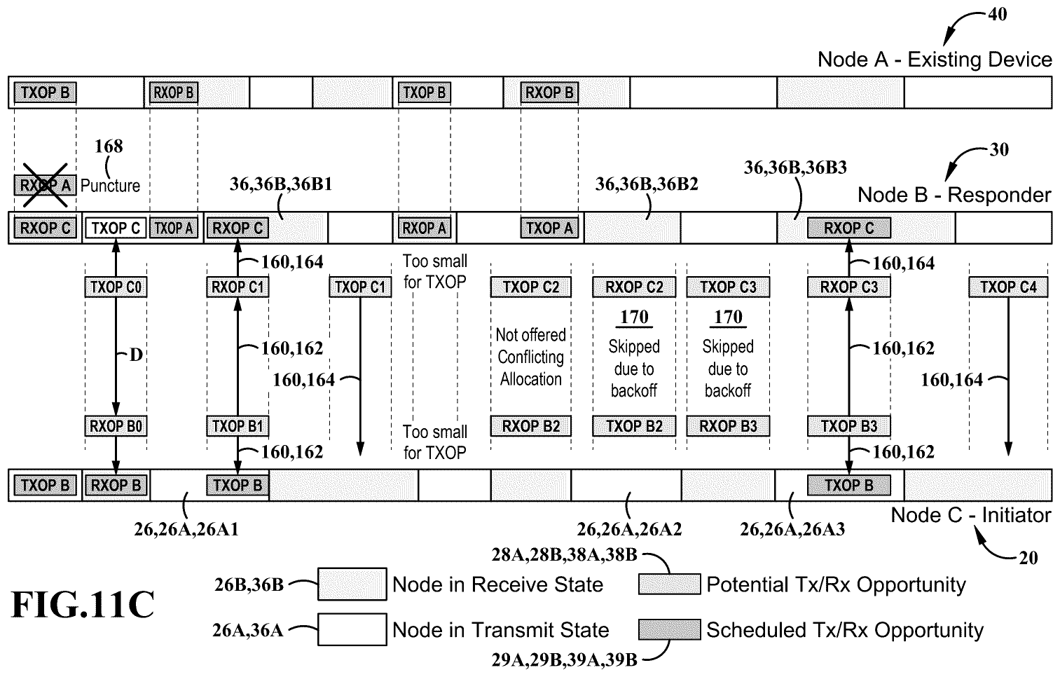

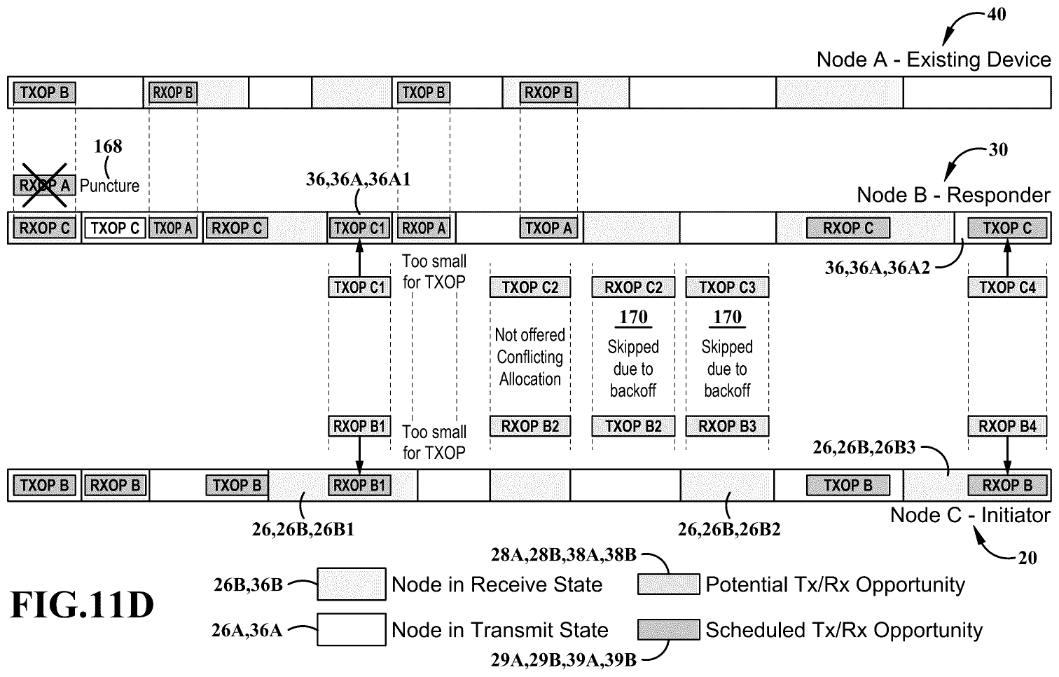

Initiator 20 also includes a first set of time intervals 26 (hereinafter “first set of time intervals”). In the present disclosure, a single bank or first set of time intervals 26 is illustrated herein for schematic and diagrammatic purposes (see FIGS. 11A-11D). In other exemplary embodiments, any suitable number of time intervals may be provided with an initiator and/or first network device for a specific operation. In operation, and as discussed in greater detail below, the first set of time intervals 26 is configured to have states of transmission or states of reception. As best seen in FIGS. 11A and 11C-11D, a first group of time intervals of the first set of time intervals 26 may be configured at a transmission state 26A to which these time intervals may only transmit signals to other devices provided in the transmission system 1 (e.g., responder 30). Still referring to FIGS. 11A and 11C-11D, a second group of time intervals of the first set of time intervals 26 may also be configured at a reception state 26B to which these time intervals may only receive signals from other devices provided in the transmission system 1 (e.g., responder 30). It should be understood the number of time intervals of the first set of time intervals 26 that are set to either a transmission state or reception state as described and illustrated herein is exemplary only and should not limit the capabilities of how many time intervals of the first set of time intervals 26 may be set or configured to a transmission state or a reception state.

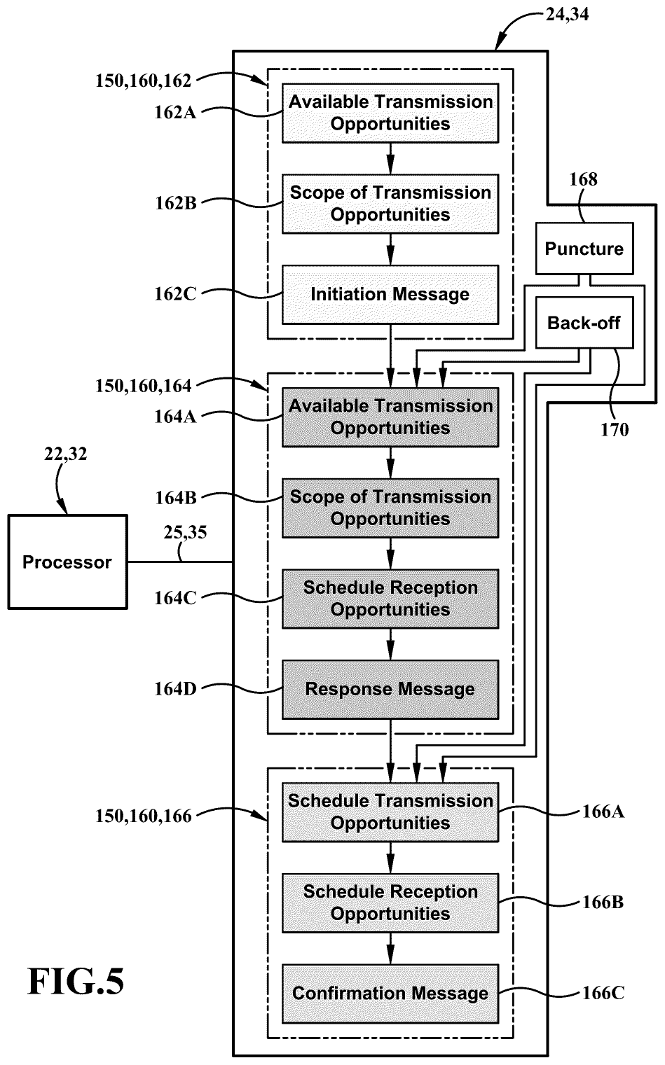

Still referring to initiator 20, each time interval of the first set of time intervals 26 may also be made up of time increments 25; each time increment 25 is denoted by a vertical dashed line labeled 25 in FIGS. 5 and 11A-11B. In the present disclosure, each time increment 25 diagrammatically shown defines a particular unit of time in a respective time interval 26 for which initiator 20 may transmit a message or receive a message based on the state of the initiator 20. As such, the set of time increments 25 form the total amount of time for each time interval 26 to which the initiator 20 may transmit messages or receive messages based on the state of the initiator 20 at a specific time interval.

Still referring to initiator 20, each time interval of the first set of time intervals 26 may also provide at least one opportunity 28 to transmit information to a corresponding receiving device provided in the transmission system 1 or to receive information from a corresponding device provided in the transmission system 1 (see FIGS. 11A-11D). It should be understood that initiator 20 may send one or more transmit opportunities 28A to a corresponding receiving device (e.g., responder 30) based on the available time intervals of the first set of time intervals 26 set to a transmit state. Similarly, it should be understood initiator 20 may also send one or more reception opportunities 28B to a corresponding receiving device (e.g., responder 30) based on the available time intervals of the first set of time intervals 26 set to a reception state. Such transmit or reception opportunities 28 are determined upon processor 22 executing the predictive contention program 50 that is discussed in greater detail below.

As best seen in FIG. 4, a transmit opportunity may include a set of time increments 25 that defines the total amount of time to which the specific transmit opportunity may transmit information from the initiator 20 to the corresponding receiving device (e.g., responder 30). In this particular example, the transmit opportunity illustrated in FIG. 11B is defined by a finite number of intervals based on the size of the opportunity for a given time interval of the first set of time intervals 26 set to a transmit state. It should be understood that this concept of time increments 25 for each time interval 26 is also provided in each reception opportunity with respect to time intervals 26 that are set to a reception state.

Still referring to initiator 20, each opportunity 28 (either a transmit opportunity 28A or a reception opportunity 28B) may also include a first set of communication slots 27 that are separate from the time intervals 26. As best seen in FIG. 11B, a transmit opportunity 28A may include a first set of communication slots 27 that defines a total amount of messages to which the specific transmit opportunity 28A may transmit information from the initiator 20 to the corresponding receiving device (e.g., responder 30). In this particular example, the transmit opportunity 28A illustrated in FIG. 11B may be defined by one or more slots (e.g., a first slot 27A, a second slot 27B, a third slot 27C) to a finite number of slots (e.g., finite number of slots 27N) based on the size of the opportunity 28 for a given communication slot of the first set of communication slots 27 set to a transmit state. It should be understood that a set of communication slots 27 is also provided in each reception opportunity 28B for a given communication slot of the first set of communication slots 27 set to a reception state.

It should be understood that the time increments 25 of each time interval 26 defined by initiator 20 may be any suitable timeframe. In one example, each time increment 25 that forms a time interval 26 may be about 10 milliseconds. In another example, each time increment 25 that forms a time interval 26 may be about 10 microseconds. It should also be understood that the time increments 25 also arbitrate the transmit and receives states of each node independent of the size of a given slot. In one instance, the time increments 25 of each time interval 26 may be less than a slot of the first set of communication slots 27. In another instance, the time increments 25 of each time interval 26 may be greater than a slot of the first set of communication slots 27. In yet another instance, the time increments 25 of each time interval 26 may be equal with a slot of the first set of communication slots 27. Such varying differences between the size of a time increment 25 and a slot 27 provided flexibility for scheduling purposes between nodes, which is discussed in greater detail below.

With respect to the responder 30, the responder 30 includes a processor 32. In the present disclosure, a processor 32 is illustrated herein for schematic and diagrammatic purposes (see FIG. 3B). In other exemplary embodiments, any suitable number of processors may be provided with an initiator and/or first network device for a specific operation. Processor 32 is configured to logically perform applications or computer program products that the processor 32 has access to prior to operation, including the predictive contention program 50 discussed in greater detail below. The processor 32 may also be powered by an on-board power source and/or power supply (e.g., portable battery, etc.) in order to logically perform applications or computer program products that are operatively in communication with the processor 32. The processor 32 may also be in logical communication with a tangible medium, such as a computer readable medium, for executing predictive contention program 50 and other computer program products discussed herein.

Responder 30 also includes at least one non-transitory computer readable medium 34 (see FIG. 3B). In the present disclosure, a single computer readable medium 34 is illustrated herein for schematic and diagrammatic purposes. In other exemplary embodiments, any suitable number of computer readable media may be provided with an initiator and/or first network device for a specific operation. Computer readable medium 34 is configured to logically store applications or computer program products that the processor 32 has access to prior to execution, such as predictive contention program 50 and other computer program products discussed herein. Computer readable medium 34 may also be powered by an on-board power source and/or power supply (e.g., portable battery, etc.) in order to be operatively in communication with the processor 32.

In the present disclosure, the computer readable medium 34 is operatively connected with the processor 32 via an electrical connection as diagrammatically illustrated, such as wire or other similar electrical connection of the like. As best seen in FIG. 3B, the computer readable medium 34 operatively connects with processor 32 by a first electrical connection 33. With such electrical connection, by the first electrical connection 33, the processor 32 and the computer readable medium 34 are enabled to communicate with one another during operation. As discussed in greater detail below, processor 32 may access and execute the predictive contention program 50 that is stored in the computer readable medium 34 to resolve and/or remove communication contention before the responder 30 and another network device, such as initiator 20, transmit and receive information between one another.

Responder 30 also includes a second set of time intervals 36. In the present disclosure, a single bank or second set of time intervals 36 is illustrated herein for schematic and diagrammatic purposes (see FIGS. 11A-11D). In other exemplary embodiments, any suitable number of time intervals may be provided with a responder and/or second network device for a specific operation. In operation, and as discussed in greater detail below, the second set of time intervals 36 is configured to have states of transmission or states of reception. As best seen in FIGS. 11A and 11C-11D, a first group of time intervals of the second set of time intervals 36 may be configured at a transmission state 36A to which these time intervals may only transmit signals to other devices provided in the transmission system 1 (e.g., initiator 20). Still referring to FIGS. 11A and 11C-11D, a second group of time intervals of the second set of time intervals 36 may also be configured at a reception state 36B to which these time intervals may only receive signals from other devices provided in the transmission system 1 (e.g., initiator 20). It should be understood the number of time intervals of the second set of time intervals 36 that are set to either a transmission state or reception state as described and illustrated herein is exemplary only and should not limit the capabilities of how many time intervals of the second set of time intervals 36 may be set or configured to a transmission state or a reception state.

Still referring to responder 30, each time interval of the second set of time intervals 36 may also be made up of time increments 35; each time increment 35 is denoted by a vertical dashed line labeled 35 in FIGS. 5 and 11A-11B. In the present disclosure, each time increment 35 diagrammatically shown defines a particular unit of time in a respective time interval 36 for which responder 30 may transmit a message or receive a message based on the state of the responder 30. As such, the set of time increments 25 form the total amount of time for each time interval 26 to which the initiator 20 may transmit messages or receive messages based on the state of the initiator 20 at a specific time interval.

Still referring to responder 30, each time interval of the second set of time intervals 36 may also provide at least one opportunity 38 to transmit information to a corresponding receiving device provided in the transmission system 1 or to receive information from a corresponding device provided in the transmission system 1 (see FIGS. 11A-11D). It should be understood that responder 30 may send one or more transmit opportunities 38A to a corresponding receiving device (e.g., initiator 20) based on the available time intervals of the second set of time intervals 36 set to a transmit state. Similarly, it should be understood responder 30 may also send one or more reception opportunities 38B to a corresponding receiving device (e.g., initiator 20) based on the available time intervals of the second set of time intervals 36 set to a reception state. Such transmit or reception opportunities 38 are determined upon processor 32 executing the predictive contention program 50 that is discussed in greater detail below.

Still referring to responder 30, each opportunity 38 (either a transmit opportunity 38A or a reception opportunity 38B) includes a second set of communication slots 37 that are smaller and embedded within the time intervals 36. Similar to the initiator 20, a transmit opportunity 38A may include a second set of communication slots 37 that defines the total amount of messages to which the specific transmit opportunity 38A may transmit information from the responder 30 to the corresponding receiving device (e.g., initiator 20). In this particular example, the transmit opportunity 38A may be defined by one or more slots (similar to the first slot 27A, the second slot 27B, and the third slot 27C provided with initiator 20) to a finite number of intervals (similar to the finite number of slots 27N shown in initiator 20) based on the size of the opportunity 38 for a given communication slot of the second set of communication slots 37 set to a transmit state. It should be understood that a second set of communication slots 37 is also provided in each reception opportunity 38B for a given communication slot of the second set of time intervals 26 set to a reception state.

As mentioned previously, transmission system 1 also includes the first computer program product or predictive contention program 50 (see FIGS. 3A-4). As discussed in greater detail below, the predictive contention program 50 may be used in conjunction with a contention free schedule program of transmission system 1 (which is discussed in greater detail below) to predict contention between the first set of time intervals 26 of the initiator 20 and the second set of time intervals 36 of the responder 30. The predictive contention program 50 instructs the processor (e.g., processor 22, 32) to set and/or establish the number of time intervals of a given set of time intervals (e.g., first and second sets of time intervals 26, 36) to a transmission state prior to initiating a contention free schedule between the initiator 20 and the responder. The predictive contention program 50 also instructs the processor (e.g., processor 22, 32) to set and/or establish the number of time intervals of a given set of time intervals (e.g., first and second sets of time intervals 26, 36) to a reception state prior to initiating a contention free schedule between the initiator 20 and the responder. Such instructions and/or steps included in the predictive contention program 50 are now discussed in greater detail below.

Similar to initiator 20, it should be understood that the time increments 35 of each time interval 36 defined by responder 30 may be any suitable timeframe. In one example, each time increment 35 that forms a time interval 36 may be about 10 milliseconds. In another example, each time increment 35 that forms a time interval 36 may be about 10 microseconds. It should also be understood that the time increments 35 also arbitrate the transmit and receives states of each node independent of the size of a given slot. In one instance, the time increments 35 of each time interval 36 may be less than a slot of the first set of communication slots 37. In another instance, the time increments 35 of each time interval 36 may be greater than a slot of the first set of communication slots 37. In yet another instance, the time increments 35 of each time interval 36 may be equal with a slot of the first set of communication slots 37. Such varying differences between the size of a time increment 35 and a slot 37 provided flexibility for scheduling purposes between nodes, which is discussed in greater detail below.

It should be understood that prior to initiating the predictive contention program 50, a discovery operation is performed by the initiator 20 to discover and find the responder 30; any suitable discovery operations may be included with the initiator 20 and all network devices of the set of network devices 20 of the transmission system 1 that discover and find other network devices provided in the transmission system 1. In the present disclosure, each of the initiator 20 and the responder 30 (as well as other network devices 10 of the transmission system 1 may emit or output a contention variable or cryptographic variable that includes information as to when given device will be transmitting information or receiving information a specific periods of time. Such contention variable is outputted by each of the initiator 20 and the responder 30 to help discover a device as well as knowing the states of transmission and reception of a network device.

With respect to the predictive contention program 50, the predictive contention program 50 includes a set of input instructions 52 that is used to generate a predictive contention schedule for a given network device of the set of network devices 10. As best seen in FIG. 3A, the set of input instructions 52 includes a schedule size input 52A that sets the number and/or size of time intervals that are to be determined by a network device 10. Stated differently, the schedule size input 52A may set the scope of the number of time intervals being evaluated by a network device 10. In one instance, the schedule size input 52A may set the total number of time intervals 26 for the initiator 20 that may be offered by the initiator 20 so that the initiator 20 may communicate with another network device, such as responder 30. It should be understood that any suitable number may be inputted herein based on the total number of time intervals a network device may dedicate for communicating with another network device in the transmission system 1. Note that alternatively, the scope could be defined as a period of time, rather than a number of intervals.

The set of input instructions 52 also includes a minimum transmission size input 52B and a minimum reception size input 52C. As best seen in FIG. 3A, the minimum transmission size input 52B is utilized for setting the minimum number of allowed time intervals of a network device of the set of network devices 10 to a transmit state (e.g., a set of time intervals configured to the transmit state 26A of initiator 20) for transmitting information to another network device from the set of network devices 10 (i.e., responder 30). Similarly, the minimum reception size input 52C is utilized for setting the minimum of allowed time intervals of a network device of the set of network devices 10 to a reception state (e.g., a set of time intervals configured to the reception state 26B of initiator 20) for receiving information from another network device of the set of network devices 10 (i.e., responder 30). Note that alternatively, these could be defined as a number of time increments directly, rather than through the use of a fixed sized intervals.

The set of input instructions 52 also includes a maximum transmission variance input 52D and a maximum reception variance input 52E. As best seen in FIG. 3A, the maximum transmission variance input 52D is utilized for setting the maximum number of allowed time intervals of a network device of the set of network devices 10 to a transmit state (e.g., a set of time intervals configured to the transmit state 26A of initiator 20) for transmitting information to another network device from the set of network devices 10 (i.e., responder 30). Similarly, the maximum reception variance input 52E is utilized for setting the maximum number of allowed time intervals of a network device of the set of network devices 10 to a reception state (e.g., a set of time intervals configured to the reception state 26B of initiator 20) for receiving information from another network device of the set of network devices 10 (i.e., responder 30). Alternatively, this may be defined as a number of time increments directly, rather than through the use of fixed sized intervals.

The maximum transmission variance input 52D and the maximum reception variance input 52E may be based on any suitable statistical method for randomly setting the maximum number of allowed time intervals of a network device of the set of network devices 10 to a transmit state and the maximum number of allowed time intervals of a network device of the set of network devices 10 to a reception state. In one instance, the maximum transmission variance input 52D and the maximum reception variance input 52E may use Gaussian statistics or standards for randomly setting the maximum number of allowed time intervals of a network device of the set of network devices 10 to a transmit state and the maximum number of allowed time intervals of a network device of the set of network devices 10 to a reception state. In another instance, the maximum transmission variance input 52D and the maximum reception variance input 52E may use uniform statistics or standards for randomly setting the maximum number of allowed time intervals of a network device of the set of network devices 10 to a transmit state and the maximum number of allowed time intervals of a network device of the set of network devices 10 to a reception state.

It should be understood that the minimum transmission size input 52B, the minimum reception size input 52C, the maximum transmission variance input 52D, and the maximum reception variance input 52E may be set at any suitable number or value dictated by the communication capabilities of specific network devices. In one instance, the minimum transmission size input 52B may be different than the minimum reception size input 52C, and the maximum transmission variance input 52D may be different than the maximum reception variance input 52E. In another instance, the minimum transmission size input 52B may be less than the minimum reception size input 52C, and the maximum transmission variance input 52D may be less than the maximum reception variance input 52E. In another instance, the minimum transmission size input 52B may be greater than the minimum reception size input 52C, and the maximum transmission variance input 52D may be greater than the maximum reception variance input 52E.

The set of input instructions 52 also includes a generating seed input 52F. As best seen in FIG. 3A, the generating seed input 52F is used to generate the seed for establishing a predictive contention schedule that may be sent and used by a receiving network device, which is discussed in greater detail below. It should be understood that the seed input by the generating seed input 52F may include information necessary to establish a predictive contention schedule between two or more network devices. In one instance, the seed inputted by the generating seed input 52F may include a key, a node identification that is specific to the network device transmitting this seed, a predetermined time when such seed will be used, and other various parameters and/or values necessary for establishing a predictive contention schedule between two or more network devices.

The predictive contention program 50 also includes a predictive contention method 54. As best seen in FIGS. 3A-3B, the predictive contention method 54 receives the set of input instructions 52 in order to generate a contention free schedule based on available time intervals that are configured at a transmit state and available time intervals that are configured at a reception state of a network device of the set of network devices 10.

Referring now to FIG. 3B, the predictive contention method 54 includes a first step 54A. Upon execution of the first step 54A by a processor of a network device (e.g., processors 22, 32) of the set of network devices 10, the processor is instructed to decide whether a first set of time intervals of the network device will be scheduled with a transmission state or with a reception state based on the set of input instructions 52 mentioned above. In this step 54A, the processor may be instructed to randomly decide whether a first set of time intervals of the network device will be scheduled with a transmission state or with a reception state.

Still referring to FIG. 3B, the predictive contention method 54 also includes a second step 54B. Upon execution of the second step 54B by the processor of the network device of the set of network devices 10, the processor is then instructed to select the state of the first set of time intervals of the network device (i.e., the transmission state or the reception state) based on the decision performed in the first step 54A.

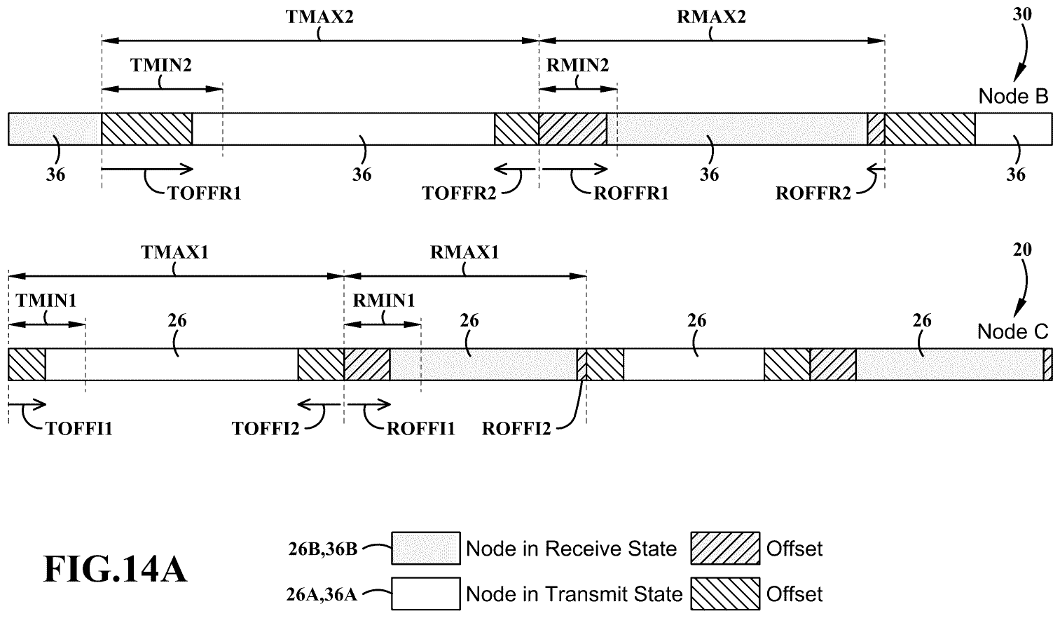

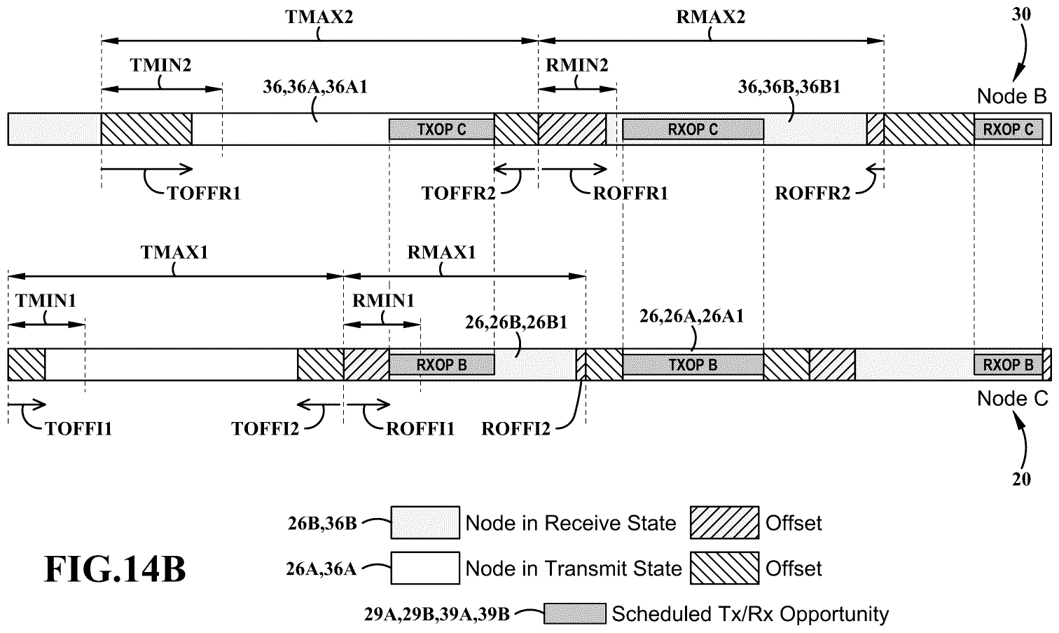

Still referring to FIG. 3B, the predictive contention method 54 also includes a third step 54C. Upon execution of the third step 54C by the processor of the network device of the set of network devices 10, the processor is then instructed to set the available number of time intervals of the first set of time intervals of the network device based on the selection performed in the second step 54B. During execution of the third step 54C, the processor uses the selected minimum size input (e.g., the minimum transmission size input 52B or the minimum reception size input 52C) and the selected maximum variance input (e.g., the maximum transmission variance input 52D or the maximum reception variance input 52E) to generate the available number of selected time intervals (see FIGS. 14A-14B). It should be noted that the third step 54C may also apply a known value to the available number of the selected time intervals (provided in either the transmission state or the reception state) to either round up or round down the available number. In one instance, the third step 54C may apply a 0.5 value to the available number of the of the selected time intervals to either round up or round down the available number.

It should be noted that steps 54A-54C are performed in more than one iteration in order to generate a desired amount of transmission time intervals (noted as 26A for initiator 20) and reception time intervals (noted as 26B for initiator 20). As such, steps 54A-54C would be performed to find the desired amount of transmission time intervals in a first iteration, and steps 54A-54C would be performed to find the desired amount of reception time intervals in a second iteration.

Upon completion of predictive contention method 54, the predictive contention program 50 outputs a schedule message 56; such schedule of each node 20, 30 is shown in FIG. 4. As best seen in FIG. 4, the schedule message 56 includes the information performed in the predictive contention method 54 by a processor of a network device of the set of network devices 10 by executing the predictive contention method 54 based on the set of input instructions 52. Once communication is established with another node of network device, the schedule message 56 is derived by another network device provided in the set of network devices 10 to establish a predictive schedule. It should be noted, however, that the schedule message 56 is performed subsequent to a discovery operation between two network devices to establish communication and/or a link between said network devices (see FIG. 4). Once the predictive contention program 50 is accomplished, nodes 20, 30 have established a link between one another for exchanging messages between one another at desired transmission time intervals 26A, 36A and at desired reception time intervals 26B, 36B.

It should be understood that such accomplishment of predictive contention program 50 between two nodes is considered advantageous at least because such predictive contention program 50 resolves duplexing contention and/or time domain duplexing (TDD). Such predictive contention program 50 is also useful in various commercially-available communication protocols or local area network protocols, including IEEE 802.11 standards.

Transmission system 1 may also include a second computer program or contention free schedule program 150 (hereinafter “schedule program 150”). As best seen in FIG. 5, the schedule program 150 is loaded into the computer readable medium 24 of the initiator 20, the computer readable medium 34 of the responder 30, and other computer readable mediums of the existing network devices 40. As such, the processors 22, 32 of the initiator 20 and the responder 30 may access and execute the schedule program 150 on the respective computer readable medium 24, 34 to resolve communication contention between the initiator 20 and the responder 30 prior to transmitting signals or receiving signals from one another. In the present disclosure, the initiator 20, the responder 30, and other devices of the transmission system 1 utilize the schedule program 150 in conjunction with the predictive contention program 50 prior to scheduling transmission and reception opportunities 28, 38. Such steps and methods of schedule program 150 are now discussed in greater detail below.

Schedule program 150 includes an initiation method 160 that is commenced by the initiator 20 to initiate a contention free schedule with the responder 30 subsequent to initiation of contention based communications methods, which are discussed above. As best seen in FIG. 5, initiation method 160 includes a set of first or initiation instructions 162 that may be accessed and executed by the processor 22 of initiator 20. With respect to the set of initiation instructions 162, the set of initiation instructions 162 includes a first step 162A that instructs the processor 22 to output next available and/or unused transmission opportunities 28A from the initiator 20 to the responder 30. In this first step 162A, the processor 22 may output one or more next available and/or unused transmission opportunities 28A from the initiator 20 to the responder 30 based on the time intervals of the first set of time intervals 26 configured to the transmission state 26A.

Still referring to FIG. 5, the set of initiation instructions 162 of the initiation method 160 also includes a second step 162B that instructs the processor 22 to set and establish a first scope for the available transmission opportunities 28A. In the present disclosure, the first scope may be a fixed value that instructs the processor 22 to set the number of available transmission opportunities 28A provided with the first set of time intervals 26 for transmitting message and/or signals from the initiator 20 to a responding network device (e.g., responder 30). It should be understood that the fixed value of the first scope accomplished in second step 162B may be any finite value that sets the number of available transmission opportunities 28A for an initiating network device (e.g., initiator 20). In one example, the fixed value of the first scope, as accomplished in the second step 162B, that sets the available transmission opportunities 28A of initiator 20 may be a value of 32. In another example, the fixed value of the first scope, as accomplished in the second step 162B, that sets the available transmission opportunities 28A of initiator 20 may be a value of 64. In another instance, the first scope accomplished in the second step 162B may be multiplied by a factor of two or more to increase the number of available transmission opportunities 28A for transmitting messages from the initiator 20 to the responder 30; such increase in the first scope may prevent the risk of reaching or running out of available transmission opportunities 28A sent from the initiator 20 to the responder 30. While the first scope accomplished in the second step 162B is a fixed value, the first scope may also be a variable value if desired.

Still referring to FIG. 5, set of initiation instructions 162 of the initiation method 160 also includes a third step 162C that instructs the processor 22 to output a contention resolution or initiation message to the responder 30. In the present disclosure, the initiation message includes the next available transmission opportunities 28A of the initiator 20 executed in the first step 162A within the first scope of available transmission opportunities 28A of the initiator 20 executed in the second step 162B.

Still referring to initiation method 160, initiation method 160 includes a set of second or response instructions 164 that may be accessed and executed by the processor 32 of responder 30. With respect to the set of response instructions 164, the set of response instructions 164 includes a first step 164A that instructs the processor 32 to output next available and/or unused transmission opportunities 38A of the second set of time intervals 36 from the responder 30 to the initiator 20. In this first step 164A, the processor 32 may output one or more next available and/or unused transmission opportunities 38A from the responder 30 to the initiator 20 based on the time intervals of the second set of time intervals 36 configured to the transmission state 36A.

Still referring to FIG. 5, the set of response instructions 164 of the initiation method 160 also includes a second step 164B that instructs the processor 32 to set and establish a second scope for the available transmission opportunities 38A. In the present disclosure, the second scope may be a fixed value that instructs the processor 32 to set the number of available transmission opportunities 38A provided with the second set of time intervals 36 for transmitting message and/or signals from the responder 30 back to the initiating network device (e.g., initiator 20). It should be understood that the fixed value of the second scope accomplished in second step 164B may be any finite value that sets the number of available transmission opportunities 38A for a responding network device (e.g., initiator 20). In one example, the fixed value of the second scope, as accomplished in the second step 162B, that sets the available transmission opportunities 38A of responder 30 may be a value of 32. In another example, the fixed value of the second scope, as accomplished in the second step 164B, that sets the available transmission opportunities 38A of responder 30 may be a value of 64. In another instance, the second scope accomplished in the second step 164B may be multiplied by a factor of two or more to increase the number of available transmission opportunities 38A for transmitting messages from the responder 30 to the initiator 20; such increase in the second scope may prevent the risk of reaching or running out of available transmission opportunities 38A sent from the responder 30 to the initiator 20. While the second scope accomplished in the second step 164B is a fixed value, the second scope may also be a variable value if desired.

Still referring to FIG. 5, the set of response instructions 164 of the initiation method 160 also includes a third step 164C that instructs the processor 32 to schedule response opportunities 39B that are available and/or open for the second set of time intervals 36 of the responder 30. In this third step 164C, the third step 164C instructs the processor 32 to take into account the next available transmission opportunities 28A received from the initiator 20 in the initiation message to schedule response opportunities 39B. In this third step 164C, the processor 32 is instructed to output one or more scheduled response opportunities 38) to the initiator 20 based on the available and/or unused time intervals for the second set of time intervals 36 of the responder 30.

Still referring to FIG. 5, set of response instructions 164 of the initiation method 160 also includes a fourth step 164D that instructs the processor 32 to output a contention resolution or response message from the responder 30 to the initiator 20. In the present disclosure, the response message includes the next available transmission opportunities 38A of the responder 30 executed in the first step 164A, the second scope of available transmission opportunities 38A of the responder 30 executed in the second step 164B, and the scheduled response opportunities 39B of the responder 30 executed in the third step 164C.

Still referring to initiation method 160, initiation method 160 includes a set of confirmation instructions 166. As best seen in FIG. 5, the set of confirmation instructions 166 includes a first step 166A that instructs the processor 22 to set and schedule the transmission opportunities 27A based on response message 164D output by the responder 30. It should be noted that the scheduled transmission opportunities 27A accomplished in this first step 166A may be different from the transmission opportunities 28A proposed in the initiation message 162C depending on the scheduled response opportunities 39B the responder 30 included in the response message 164D outputted by the responder 30.

Still referring to FIG. 5, the set of confirmation instructions 166 of the initiation method 160 also includes a second step 166B that instructs the processor 22 of the initiator 20 to select and schedule response opportunities 27B that are available and/or open in the first set of time intervals 26 of the initiator 20. In this second step 166B, the second step 166B instructs the processor 22 to take into account the next available transmission opportunities received from the responder 30 in the response message 164D for scheduling and setting response opportunities 27B. In this second step 166B, the processor 22 is instructed to output one or more scheduled response opportunities to the responder 30 based on the available and/or unused time intervals of the first set of time intervals 26 of the initiator 20.

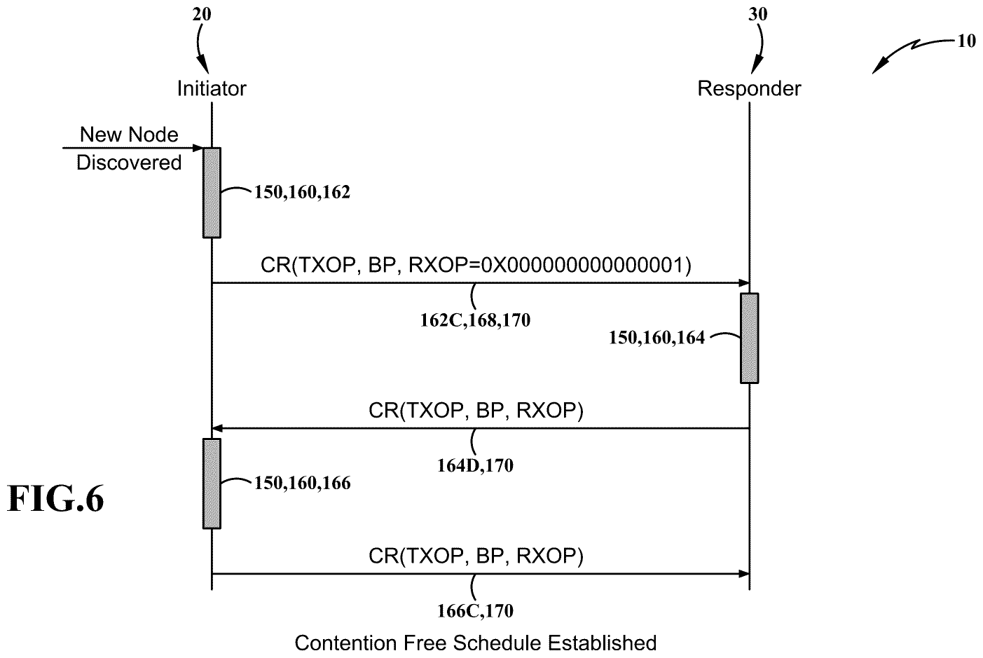

Still referring to FIG. 5, set of confirmation instructions 166 of the initiation method 160 also includes a third step 166C that instructs the processor 22 to output a contention free schedule or confirmation message to the responder 30. In the present disclosure, the confirmation message includes the scheduled transmission opportunities 27A of the initiator 20, as executed in the first step 166A, in response to the scheduled response opportunities 39B provided by responder 30, and the scheduled response opportunities 27B of the initiator 20, as executed in the second step 166B, in response to the transmission opportunities 38A provided by responder 30. Such execution of the third step 166C establishes a contention free schedule between the initiator 20 and the responder 30 (see FIG. 6).

Optionally, a processor (e.g., processor 22) of a network device (e.g., initiator 20) of the set of network devices 10 may initiate a puncture step 168 to establish a contention free schedule with another network device of the set of network devices 10 (e.g., responder 30). In one instance, and as best seen in FIG. 5, the processor 22 of the initiator 20 may be instructed to puncture a schedule between the responder 30 and an existing network device 40 of the set of network devices 10 upon executing the puncture step 168; such act of puncturing by the initiator 20 will provide priority to the initiator 20 over the existing network device 40 that is currently in communication with the responder 30 upon use of the schedule program 150. It should be noted that such execution of the puncture step 168 by processor 22 is executed concurrently with the set of initiation instructions 162 such that the puncture step 168 is included with the initiation message 62C. It should be understood that any suitable applications or computer program products of puncturing may be used herein in order to establish a contention free schedule between two or more network devices of the set of network devices 10. In one exemplary embodiment, the puncture step 168 may be performed by both the initiator 20 and the responder 30 when the initiator 20 and the responder 30 are each scheduled with preexisting nodes or devices prior to discovering one another (e.g., preexisting device 40). In this exemplary embodiment, one or both of the initiator 20 and the responder 30 may puncture a scheduled communication with the preexisting node in order to establish a communication schedule between one another.

Optionally, a processor (e.g., processors 22, 32) of a network device (e.g., initiator 20 or responder 30) of the set of network devices 10 may also be limited to transmitting and/or offering a certain number of time intervals from a set of time intervals due to back-off protocols and/or standards that are commonly used in transmission systems. In one instance, and as best seen in FIG. 5, processor 22 of the initiator 20 may execute a back-off step 170 to instruct the processor 22 to limit the offerings of time intervals from the first set of time intervals 26 (time intervals that are configured in the transmit state 26A or the reception state 26B) due to back-off protocols and/or standards. Similarly, in another instance, processor 32 of the responder 30 may also execute the back-off step 170 to instruct the processor 32 to limit offerings of time intervals from the second set of time intervals 36 (time intervals that are configured in the transmit state 36A or the reception state 36B) due to back-off protocols and/or standards. Such execution of the back-off step 170 by the network devices 10 discussed herein is generally used so that network devices 10 may have multiple opportunities to communicate with other network devices at different transmission periods and receptions periods.

It should be understood that the initiator 20 will send a predetermined number of opportunities (in this case, transmission opportunities) dependent upon the backoff parameter set by the responder 30 when specified during execution of the set of initiations instructions 162. In one example, responder 30 may specify the lowest backoff parameter (e.g., a value of 1) which allows initiator 20 to send as many available transmission opportunities as possible to responder 30. In another example, responder 30 specify a higher backoff parameter (e.g., a value of 2 or greater) that limits initiator 20 in sending a smaller amount of available transmission opportunities to responder 30. Such specification of a backoff parameter is used based on the preexisting communication schedules established between other nodes and/or devices.

It should be understood that prior to initiating the schedule program 150 between the initiator 20 and the responder 30, a discovery operation is performed by the initiator 20 to discover and find the responder 30; any suitable discovery operations may be included with the initiator 20 and all network devices of the set of network devices 20 of the transmission system 1 that discover and find other network devices provided in the transmission system 1. As discussed previously with respect to the discovery operation, each of the initiator 20 and the responder 30 (as well as other network devices 10 of the transmission system 1) outputs a contention variable or cryptographic variable that includes information as to when given device will be transmitting information or receiving information a specific periods of time; such cryptographic variable starts the predictive contention program 50 which enables the start of schedule program 150. Such contention variable is outputted by each of the initiator 20 and the responder 30 to help discover a device as well as knowing the states of transmission and reception of a network device.

It should also be understood that prior to initiating the schedule program 150 between the initiator 20 and the responder 30, initiator 20 and responder 30 execute predictive contention program to prevent duplexing contention between both the initiator 20 and the responder 30.

It should also be understood that certain sets of instructions of the schedule program 150 are executed by certain network devices of the set of network devices 10. As discussed herein, a processor of an initiator (e.g., processor 22 of initiator 20) may access and execute the set of initiation instructions 162, the set of confirmation instructions 166, the puncturing step 168 (if needed), and the back-off step 170 (if needed). Additionally, a processor of a responder (e.g., processor 32 of responder 30) may access and execute the set of response instructions 164, the puncturing step 168 (if needed), and the back-off step 170 (if needed).

Schedule program 150 may also include a maintenance method 180. In operation, one or more processors of network devices of the set of network devices 10 may access and execute the maintenance method 180 subsequent to accessing and executing the initiation method 160 that established the contention free schedule between the network devices 10. Such maintenance method 180 may be accessed and executed by one or more processors of network devices of the set of network devices 10 when the initial number of time intervals (having the transmit state) scheduled between the network device in the initiation method 160 is approached or is close to being approached. It should be noted that the maintenance method 180 may be executed one or more times depending on the number of available time intervals (configured for transmission or reception) between an initiator and a responder. The sets of instructions and steps included in the maintenance method 180 are discussed in greater detail below.

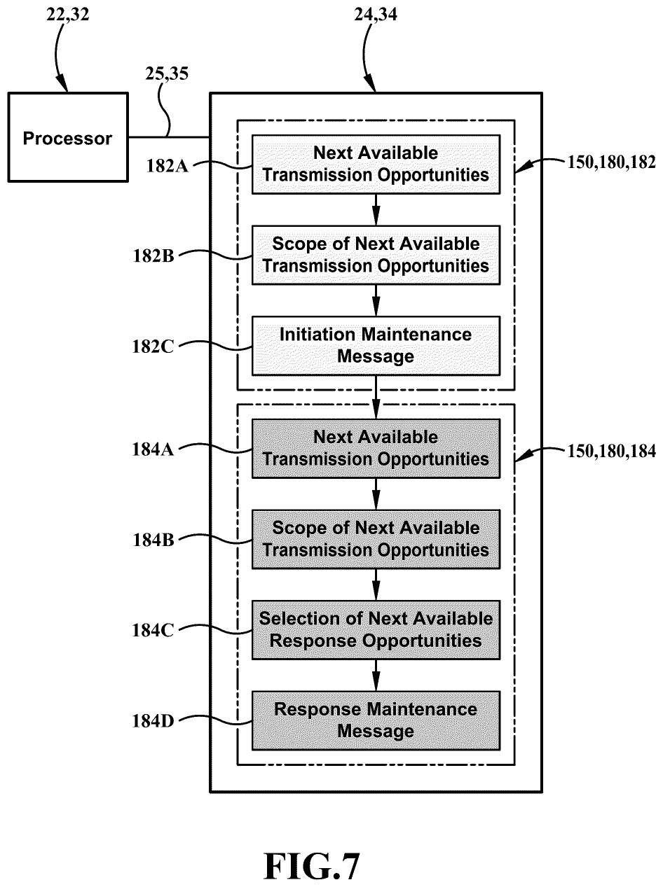

With respect to the maintenance method 180, maintenance method 180 includes a set of first maintenance instructions 182. As best seen in FIG. 7, the set of first maintenance instructions 182 includes a first step 182A that instructs the processor 22 to output next available and/or unused transmission opportunities 28A from the initiator 20 to the responder 30. In this first step 182A, the processor 22 may output one or more next available and/or unused transmission opportunities 28A from the initiator 20 to the responder 30 based on the next available and/or unused time intervals of the first set of time intervals 26 of the initiator 20. It should be noted that such next available and/or unused transmission opportunities 28A of the first set of time intervals 26 may be previously sent transmission opportunities 28A used in the set of initiation instructions 162 or are new transmission opportunities 28A not previously available to the initiator 20 upon execution of the set of initiation instructions 162.

Still referring to FIG. 7, the set of first maintenance instructions 182 includes a second step 182B that instructs the processor 22 to set and establish a third scope for the available transmission opportunities 28A that is greater than the first scope established in the initiation method 160. Similar to the first scope set upon execution of the initiation method 160, the third scope may be a fixed value that instructs the processor 22 to set the number of available transmission opportunities 28A provided with the first set of time intervals 26 for transmitting message and/or signals from the initiator 20 to a responding network device (e.g., responder 30). It should be understood that the fixed value of the third scope accomplished in second step 182B may be any finite value that sets the number of available transmission opportunities 28A for an initiating network device (e.g., initiator 20). In one example, the fixed value of the third scope, as accomplished in the second step 182B, that sets the available transmission opportunities 28A of initiator 20 may be a value of 32. In another example, the fixed value of the third scope, as accomplished in the second step 182B, that sets the available transmission opportunities 28A of initiator 20 may be a value of 64. In another instance, the third scope accomplished in the second step 182B may be multiplied by a factor of two or more to increase the number of available transmission opportunities 28A for transmitting messages from the initiator 20 to the responder 30; such increase in the third scope may prevent the risk of reaching or running out of available transmission opportunities 28A sent from the initiator 20 to the responder 30. While the third scope accomplished in the second step 182B is a fixed value, the third scope may also be a variable value if desired.

Still referring to FIG. 7, set of first maintenance instructions 182 of the maintenance method 180 also includes a third step 182C that instructs the processor 22 to output a maintenance initiation message from the initiator 20 to the responder 30. In the present disclosure, the maintenance initiation message includes the next available transmission opportunities of the initiator 20 executed in the first step 182A and the third scope of available transmission opportunities 28A executed in the second step 182B.

Still referring to FIG. 7, maintenance method 180 includes a set of second maintenance instructions 184. In the present disclosure, the set of second maintenance instructions 184 includes a first step 184A that instructs the processor 32 to output next available and/or unused transmission opportunities 38A of the second set of time intervals 36 from the responder 30 to the initiator 20. In this first step 184A, the processor 32 may output one or more next available and/or unused transmission opportunities 38A of the second set of time intervals 36 from the responder 30 to the initiator 20 based on the available and/or unused time intervals of the second set of time intervals 36. It should be noted that such next available and/or unused transmission opportunities 38A of the second set of time intervals 36 may be previously sent transmission opportunities 38A used in the set of response instructions 164 or are new transmission opportunities 38A not previously available to the responder 30 upon execution of the set of response instructions 164.

Still referring to FIG. 7, the set of second maintenance instructions 184 includes a second step 184B that instructs the processor 32 to set and establish a fourth scope for the available transmission opportunities 38A that is greater than the second scope established in the initiation method 160. Similar to the second scope set upon execution of the initiation method 160, the fourth scope may be a fixed value that instructs the processor 32 to set the number of available transmission opportunities 38A provided with the second set of time intervals 36 for transmitting message and/or signals from the responder 30 to the initiating network device (e.g., initiator 20). It should be understood that the fixed value of the fourth scope accomplished in second step 184B may be any finite value that sets the number of available transmission opportunities 38A for a responding network device (e.g., responder 30). In one example, the fixed value of the fourth scope, as accomplished in the second step 184B, that sets the available transmission opportunities 38A of responder 30 may be a value of 32. In another example, the fixed value of the fourth scope, as accomplished in the second step 184B, that sets the available transmission opportunities 38A of responder 30 may be a value of 64. In another instance, the fourth scope accomplished in the second step 184B may be multiplied by a factor of two or more to increase the number of available transmission opportunities 38A for transmitting messages from the responder 30 to the initiator 20; such increase in the fourth scope may prevent the risk of reaching or running out of available transmission opportunities 38A sent from the responder 30 to the initiator 20. While the fourth scope accomplished in the second step 184B is a fixed value, the fourth scope may also be a variable value if desired.

Still referring to FIG. 7, the set of second maintenance instructions 184 of the maintenance method 180 also includes a third step 184C that instructs the processor 32 to schedule response opportunities 39B that are available and/or open in the second set of time intervals 36 of the responder 30. Similar to the set of response instructions 164, the third step 184C may instruct the processor 32 to take into account the next available transmission opportunities received from the initiator 20 in the maintenance message. In this third step 184C, the processor 32 is instructed to output one or more scheduled or selected response opportunities to the initiator 20 based on the available and/or unused time intervals of the second set of time intervals 36 of the responder 30.

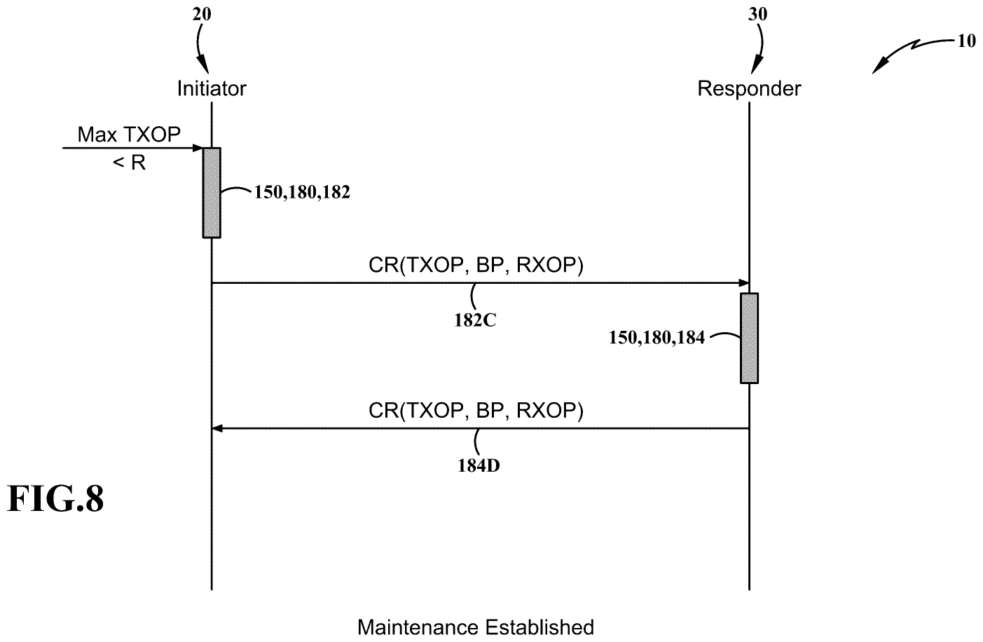

Still referring to FIG. 7, the set of second maintenance instructions 184 of the maintenance method 180 also includes a fourth step 184D that instructs the processor 32 to output a contention resolution or maintenance response message from the responder 30 to the initiator 20. In the present disclosure, the maintenance response message includes the next available transmission opportunities executed in the first step 184A, the fourth scope of available transmission opportunities 38A provided by the responder 30 as executed in the second step 184B, and the scheduled response opportunities executed in the third step 184C. Once the maintenance response message of the set of second maintenance instruction is received by the initiator 20, the contention free schedule is updated between the initiator 20 and the responder 30 (see FIG. 8).

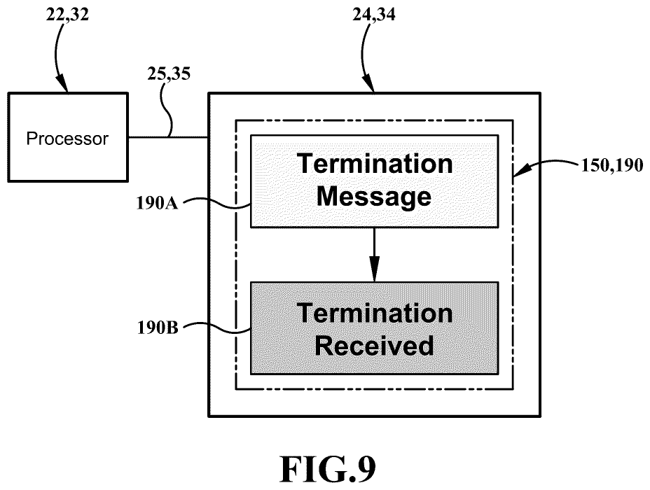

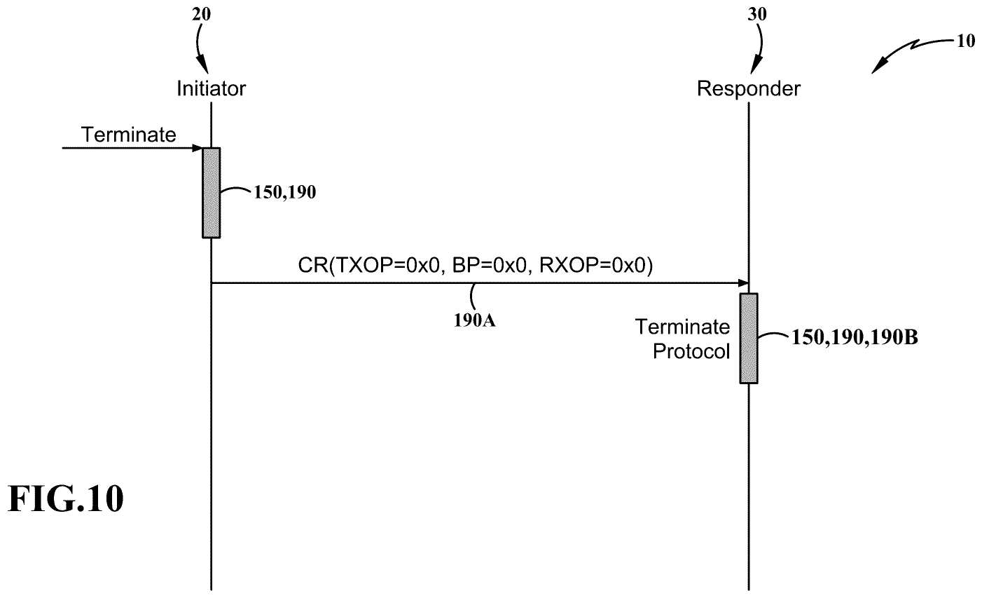

Schedule program 150 may also include a termination method 190 (see FIG. 9). In operation, a processor of a network device of the set of network devices 10 may access and execute the termination method 190 subsequent to accessing and executing the initiation method 160 and/or the maintenance method 180. Such termination method 190 may be accessed and executed by a processor of a network device of the set of network devices 10 when the network device ceases to communicate with another network device. In operation, the initiating device (e.g., initiator 20) may execute the termination method 190 by sending a termination message 190A to the responding device (e.g., the responder 30) in which the responding device receives the termination message 190B. It should be noted that once the termination method 190 is complete and the termination message is received 190B by the responding device, all communication between these network devices ceases. However, communication can be restored if one of the network devices accesses and executes the initiation method 160 to establish a new contention free schedule.

Such scheduling program 150 is considered advantageous at least because scheduling program 150 resolves link contention or interlink contention between two nodes. In addition, it may be used to resolve resource contention within a node where those resources could be signal processing, processor, memory and available power for example. In one instance, the scheduling program 150 creates a contention resolution between the two nodes where the scheduling program 150 reserves transmission time intervals (e.g., transmission time intervals 26A, 36A) along with respective transmission opportunities (e.g., transmission opportunities 28A, 38A) between the two nodes. In this same instance, the scheduling program 150 also creates a contention resolution between the two nodes where the scheduling program 150 reserves reception time intervals (e.g., reception time intervals 26B, 36B) along with respective reception opportunities (e.g., transmission opportunities 28B, 38B) between the two nodes.

Having now described the schedule program 150 of the transmission system 1, a method of using the schedule program 150 to establish a contention free schedule between two nodes or two network devices is discussed in greater detail below.

In this example, a first node or preexisting device 40 (labeled “Node A” in FIGS. 11A-11D) and a second node or responder 30 (labeled “Node B” in FIGS. 11A-11D) are shown having a preexisting communication schedule with one another. While such preexisting communication schedule is established, a third node or initiator 20 (labeled “Node C” in FIGS. 11A-11D) may try to establish contention free communications with the responder 30 due to the initiator 20 and the responder 30 being loaded with the schedule program 150. It should be understood, however, that the initiator 20 found and/or discovered the responder 30 by performing a discovery operation that is separate from the schedule program 150. In this discovery operation, the initiator 20 dedicates a first communication time interval 26A1 configured to a transmit state (also denoted “TXOP B0” in FIG. 11A) to transmit the discovery operation to the responder 30, and the responder 30 dedicates a first time interval 36B1 configured to a reception state (also denoted “RXOP C0” in FIG. 11A) to receive the discovery message sent by the initiator 20; such discovery operations are denoted by an arrow labeled “D” in FIG. 11A. In this discovery operation, initiator 20 also initiates the puncture step 168 since the first reception time interval 36B1 of the responder 30 was scheduled to receive transmissions from the preexisting device; such action of puncturing is denoted by an “X” placed over the existing reception time interval labeled “RXOP A” in FIG. 11A. Additionally, the initiator 20 and the responder 30 perform the predictive contention method 50 to establish the number of opportunities for transmitting and receiving messages between one another (as discussed above).

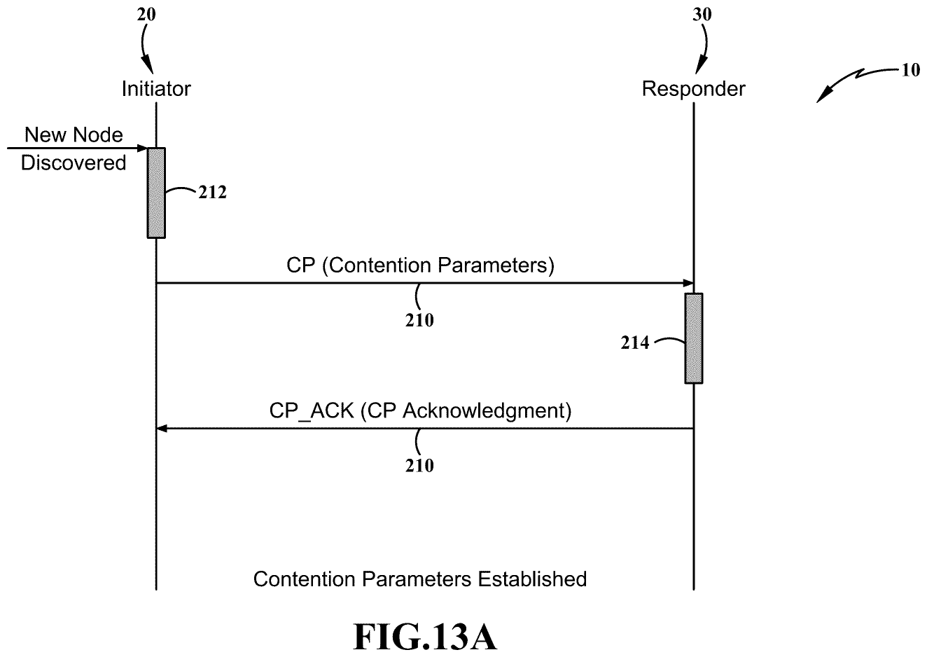

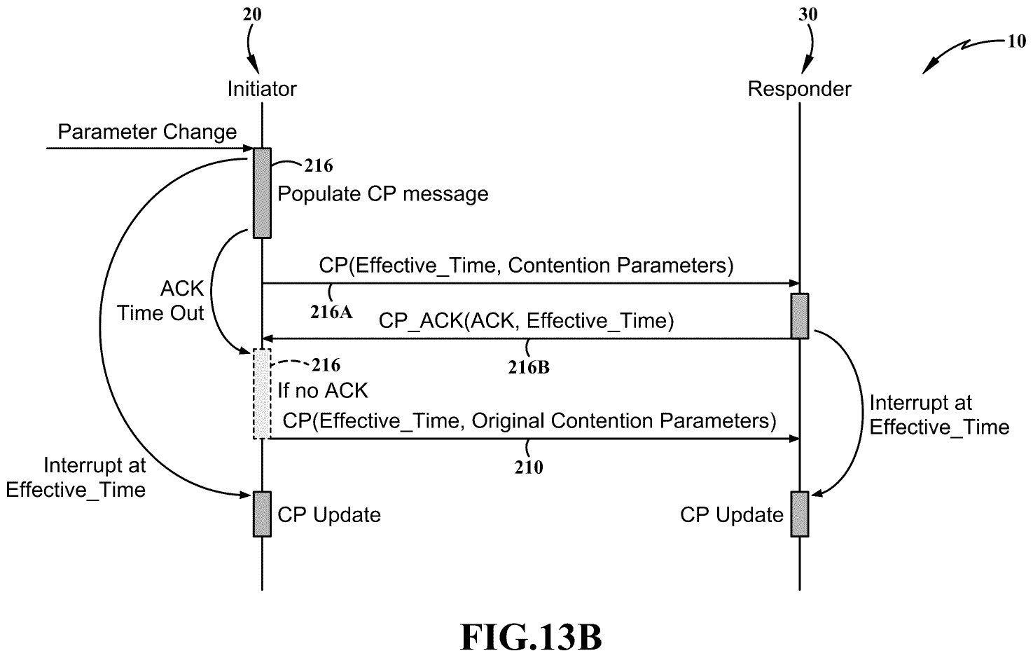

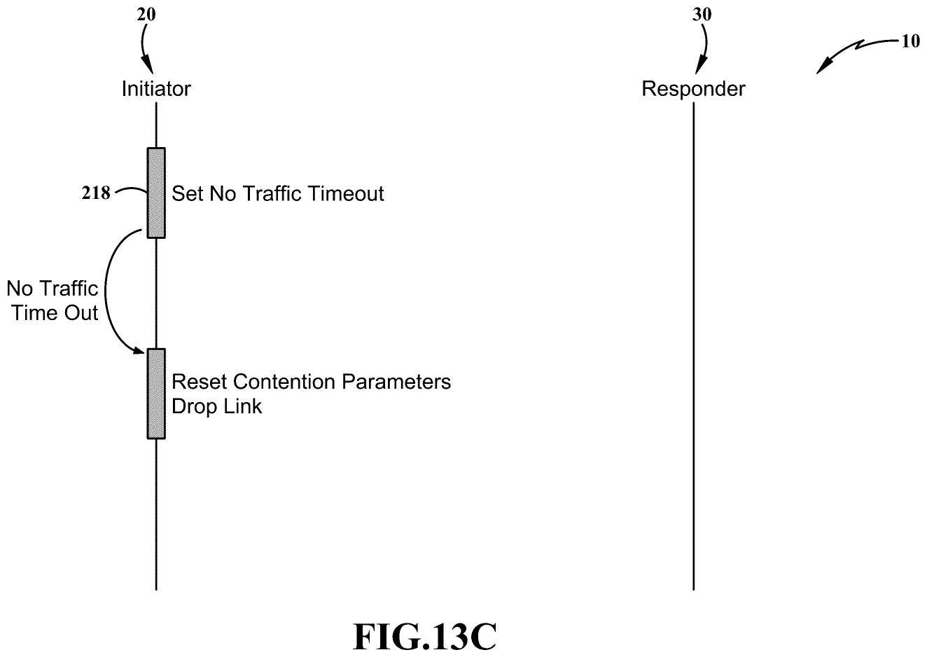

It should be understood that during the discovery operation (as denoted by the arrow labeled “D” in FIG. 11A), the two nodes 20, 30 negotiated to use and/or execute the schedule program 150. At this stage, the node that has the first available transmission opportunity (in this case node 20) becomes the initiator to being the scheduling process encoded in the schedule program 150. As such, the second node 30 becomes the responder due to node 30 failing to have an available transmission opportunity that is earlier than the first available transmission opportunity of node 20. Note that the initial schedule resolution could potentially occur during discovery as well, and also the initial instance of the control of predictive contention protocol (FIG. 13A).

Once communication is established between the initiator 20 and the responder 30, the initiator 20 begins executing the initiation method 160 to establish a contention free schedule between the initiator 20 and the responder 30. First, the set of initiation instructions 162 is performed by the initiator 20 by offering and/or outputting at least one transmission opportunity to the responder 30. As best seen in FIG. 11A, the initiator 20 offers the next three available transmission opportunities 28A to the responder 30 (denoted by boxes labeled “TXOP B1”, “TXOP B2”, and “TXOP B3”) upon executing the set of initiation instructions 162 to establish opportunities of transmission from the initiator 20 to the responder 30. It should be noted that the next three available transmission opportunities offered to the responder 30 correspond to the next three available time intervals 26A1, 26A2, 26A3 of the first set of time intervals 26 that are configured to the transmit state.

As each transmission opportunity 28A is sent from the initiator 20 to the responder 30, each transmission opportunity 28A may include a set of communication slots 27 for setting distinct time periods to transmit a message (see FIG. 11B). In this particular example, the transmit opportunity 28A is defined by one or more slots (e.g., a first slot 27A, a second slot 27B, a third slot 27C) to a finite number of intervals (e.g., finite number of slots 27N) based on the size of the opportunity 28 for a given communication time interval of the first set of time intervals 26 set to a transmit state. While not illustrated herein, a set of communication slots 27 is also provided in each reception opportunity 28B for a given communication time interval of the first set of time intervals 26 that is set to a reception state.

Once the next available transmission opportunities of the initiator 20 are received by the responder 30, the responder 30 then performs the set of response instructions 164 by offering and/or outputting at least one transmission opportunity 38A to the initiator 20. As best seen in FIG. 11C, the responder 30 offers the next three available transmission opportunities 38A to the initiator 20 (denoted by boxes labeled “TXOP C1”, “TXOP C3”, and “TXOP C4”) upon executing the set of response instructions 164 to establish opportunities of transmission from the responder 30 to the initiator 20. It should be noted that the next three available transmission opportunities 38A offered to the initiator 20 correspond to the next three available communication time intervals 36A1, 36A2, 36A3 of second set of time intervals 36 configured to the transmit state.

Similar to the initiator 20, each transmission opportunity 38A sent from responder 30 also includes a set of communication slots (similar to set of communication slots 27) for setting distinct time periods to transmit a message. In one particular example, the transmit opportunity 38A may be defined by one or more slots (like first slot 27A, second slot 27B, third slot 27C) to a finite number of slots (like finite number of slots 27N) based on the size of the opportunity 38 for a given communication time interval of the second set of time intervals 36 set to a transmit state. While not illustrated herein, a set of communication slots is also provided in each reception opportunity 38B for a given communication time interval of the second set of time intervals 36 that is set to a reception state.

While performing the set of response instructions 164, the responder 30 concurrently accepts at least one response opportunity based on the next available transmission opportunities of the initiator 20. As best seen in FIG. 11C, the responder 30 accepts two response opportunities 39B (denoted by boxes labeled “RXOP C1” and “RXOP C3”) and outputs the same to the initiator 20 upon executing the set of response instructions 164 for establishing opportunities of reception from the initiator 20. Once accepted, the two available response opportunities 39B of the responder 30 are scheduled at the two available reception time intervals 36B1, 36B2 of the group of reception time intervals 36B of the second set of time intervals 36. It should be noted that in this particular embodiment, the second available transmission opportunity (“TXOP B2”) of the initiator 20 cannot be accepted due to a conflicting schedule between responder 30 and the preexisting device 40 (See FIG. 11C).

Once the set of response instructions 164 is complete, the initiator 20 accepts and schedules at least one response opportunity 29B based on the next available transmission opportunities of the responder 30 when performing the set of confirmation instructions 166. As best seen in FIG. 11D, the initiator 20 accepts two response opportunities 29B to the initiator 20 (denoted by boxes labeled “RXOP B1” and “RXOP B4”) upon executing the set of confirmation instructions 166 to establish opportunities of reception from the responder 30. Once accepted, the two available response opportunities 39B of the initiator 20 are scheduled at the two available time intervals 26B1, 26B2 of the first set of time intervals 26 that are set to a receive state. It should be noted that the second available transmission opportunity (“TXOP C3”) of the responder 30 cannot be accepted due to a back-off operation provided with the initiator 20.

As mentioned previously, the initiator 20 and the responder 30 may include the back-off step 170 to allow other network devices or nodes of the set of network devices 10 for communication purposes. In this example, the initiator 20 and the responder 30 randomly select at least one back-off opportunity where transmission opportunities (denoted by boxes labeled “TXOP B2” and “TXOP C3”) and response opportunities (denoted by boxes labeled “RXOP B3” and “RXOP C2”) are prevented between the initiator 20 and the responder 30.

In this example, the initiator 20 and the responder 30 may also be prevented to communicate with one another due to the size of a time interval provided in the first set of time intervals 26 of the initiator 20 or in the second set of time intervals 36 of the responder 30. As shown herein, at least one time interval of the second set of time intervals 36 of the responder 30 that is set to a receive state is too small to receive transmission signals from at least one transmission time interval of the first set of time intervals 26 of the initiator 20 that is set to a transmit state.

Transmission system 1 may also include a third computer program product or a predictive contention control program 200 (hereinafter “control program 200”). As discussed in greater detail below, the control program 200 is executed to control contention with first set of time intervals 26 of the initiator 20 and the second set of time intervals 36 of the responder 30 by setting the sizes of the first set of time intervals 26 of the initiator 20 and the second set of time intervals 36 of the responder 30. When executed by at least the processor 22 of the initiator 20 upon accessing the computer stored medium 24, the control program 200 instructs the processor 22 to set the sizes of the first set of time intervals 26 and the second set of time intervals 36. When executed by at least the processors 22, 32 of the initiator 20 and the responder 30 upon accessing the computer stored mediums 24, 34, the control program 200 also instructs the processors 22, 32 to set desired time offsets for starting or ending transmission of signals and reception of signals. Such instructions and/or steps included in the control program 200 are now discussed in greater detail below.

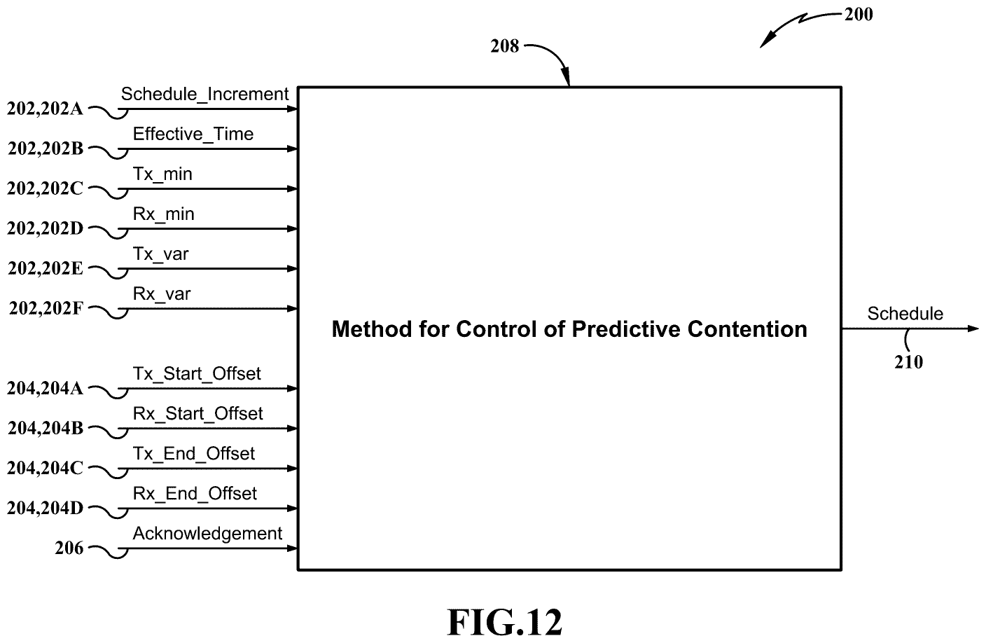

The set of input parameters 202 includes a schedule increment input 202A. As best seen in FIG. 12, the schedule increment input 202A is utilized to input the number of time increments that may be output and/or offered at desired time intervals. It should be understood that any suitable number or value may be provided by the schedule increment input 202A based on the number of available time intervals provided in the specific network device. It should also be understood that any suitable time increment may be used for schedule increment input 202 based on the transmission and reception capabilities provided in a specific network device. Examples of suitable time increments of the schedule increment input 202 may be milliseconds, microseconds, or other suitable time increments dictated by the implementation of control program 200.

The set of input parameters 202 also includes an effective time input 202B. As best seen in FIG. 12, the effective time input 202B inputs when the parameters of the control program 200 will take effect between two or more network devices of the set of network devices 10. It should also be understood that any suitable time value may be used for effective time input 202B based on the transmission and reception capabilities provided in a specific network device. In one instance, the time increment of the effective time input 202B may be in milliseconds. The time value could be an absolute time, or relative to an epoch boundary of some sort, or the transmission time of the control message.

The set of input parameters 202 also includes a minimum transmission size input 202C and a minimum reception size input 202D; these inputs may also be used and shared by the predictive contention program 50. As best seen in FIG. 12, the minimum transmission size input 202C is utilized for setting the minimum number of time intervals of a network device of the set of network devices 10 to a transmit state (i.e., time intervals 26 of the initiator 20 set to a transmit state 26A) that is used to transmit information to another network device from the set of network devices 10 (i.e., responder 30). Similarly, the minimum reception size input 202D is utilized for setting the minimum number of time intervals of a network device of the set of network devices 10 to a receive state (i.e., time intervals 26 of the initiator 20 set to a receive state 26B) that is used to receive information from another network device of the set of network devices 10 (i.e., responder 30).

The set of input parameters 202 also includes a maximum transmission variance input 202E and a maximum reception variance input 202F; these inputs may also be used and shared by the predictive contention program 50. As best seen in FIG. 12, the maximum transmission variance input 202E is utilized for setting the maximum number of time intervals of a network device of the set of network devices 10 to a transmit state (i.e., time intervals 26 of the initiator 20 set to a transmit state 26A) that is used to transmit information to another network device from the set of network devices 10 (i.e., responder 30). Similarly, the maximum reception variance input 202F is utilized for setting the maximum number of time intervals of a network device of the set of network devices 10 (i.e., time intervals 26 of the initiator 20 set to a receive state 26B) that is used to receive information from another network device of the set of network devices 10 (i.e., responder 30).

The maximum transmission variance input 202E and the maximum reception variance input 202F may be based on any suitable statistical method for randomly setting the maximum number of time intervals to a transmit state of a network device of the set of network devices 10 and the maximum number of time intervals to a receive state of a network device of the set of network devices 10. In one instance, the maximum transmission variance input 202E and the maximum reception variance input 202F may use Gaussian statistics or standards for randomly setting the maximum number of time intervals to a transmit state of a network device of the set of network devices 10 and the maximum number of time intervals to a receive state of a network device of the set of network devices 10. In another instance, the maximum transmission variance input 202E and the maximum reception variance input 202F may use uniform statistics or standards for randomly setting the maximum number of time intervals to a transmit state of a network device of the set of network devices 10 and the maximum number of time intervals to a receive state of a network device of the set of network devices 10.

It should be understood herein that the minimum transmission size input 202C, the minimum reception size input 202D, the maximum transmission variance input 202E, and the maximum reception variance input 202F may be set at any suitable number or value dictated by the communication capabilities of specific network devices. In one instance, the minimum transmission size input 202C may be different than the minimum reception size input 202D, and the maximum transmission variance input 202E may be different than the maximum reception variance input 202F. In another instance, the minimum transmission size input 202C may be less than the minimum reception size input 202D, and the maximum transmission variance input 52D may be less than the maximum reception variance input 202F. In another instance, the minimum transmission size input 202C may be greater than the minimum reception size input 202D, and the maximum transmission variance input 202E may be greater than the maximum reception variance input 202F.

Control program 200 also includes a set of offset input parameters 204. As best seen in FIG. 12, the set of offset input parameters 204 includes a transmission start offset input 204A and a reception start offset input 204B. In the present disclosure, the transmission start offset input 204A sets a desired start time for each communication time interval configured to a transmit state of a network device of the set of network devices 10 (i.e., first set of time intervals 26 of initiator 20 that is configured to a transmit state 26A) to delay transmission of information to another network device from the set of network devices 10 (i.e., responder 30). Similarly, the reception start offset input 204B is utilized for setting a desired start offset for each communication time interval configured to a receive state of a network device of the set of network devices 10 (i.e., first set of time intervals 26 of initiator 20 that is configured to a receive state 26B) to delay reception of information from another network device from the set of network devices 10 (i.e., responder 30).

Still referring to FIG. 12, the set of offset input parameters 204 includes a transmission end offset input 204C and a reception end offset input 204D. In the present disclosure, the transmission end offset input 204C sets a desired end offset for each communication time interval configured to a transmit state of a network device of the set of network devices 10 (i.e., first set of time intervals 26 of initiator 20 that is configured to a transmit state 26A) to terminate transmission of information to another network device from the set of network devices 10 (i.e., responder 30). Similarly, the reception end offset input 204D sets a desired end offset for each communication time interval configured to a receive state of a network device of the set of network devices 10 (i.e., first set of time intervals 26 of initiator 20 that is configured to a receive state 26B) to terminate reception of information from another network device from the set of network devices 10 (i.e., responder 30).

It should be understood herein that the transmission start offset input 204A, the reception start offset input 204B, the transmission end offset input 204C, and the reception start end input 204D may be set at any suitable value of time offset dictated by the communication capabilities of specific network devices.

Such inclusion of the transmission start offset input 204A, the reception start offset input 204B, the transmission end offset input 204C, and the reception start end input 204D is considered advantageous at least because such offsets may account various technology differences and/or capabilities between two or more network devices. In one example, the transmission start offset input 204A and the reception start offset input 204B allows a network device to delay transmission of signals or delay reception of signals when trying to communicate with another network device that receives signals at a delay time interval or transmits at a delay time interval due to legacy and/or archaic technology (e.g., a disadvantaged node or network device). In another example, the transmission end offset input 204C and the reception end offset input 204D allows a network device to terminate the transmission of signals earlier or to terminate reception of signals earlier when communicating with another network device due to the advanced technology or capabilities of the network device (e.g., an advantageous node).

Control program 200 also includes an acknowledgement message 206. As best seen in FIG. 12, the acknowledgment message 206 is included with the set of input parameters 202 and the set of offset input parameters 204 by initiator node 20. In general, the acknowledgement message 206 is included so that the receiving network device (e.g., responder 30) may acknowledge the set of input parameters 202 and the set of offset input parameters 204 from the transmitting network device (e.g., initiator 20). If, however, the acknowledgement message 206 is not received by the receiving network device, the transmitting network device may resend the request for acknowledgement message 206 to the receiving network device (along with the set of input parameters 202 and the set of offset input parameters 204) until the receiving network device receives the acknowledgement message 206. However, if the acknowledgement message 206 is not received, the parameters provided by the control program 200 will not be used between the transmitting network device and the receiving network device; in this instance, the initial parameters communicated between the transmitting network device and the receiving network device will be used.

Control program 200 also includes a control method 208. As best seen in FIG. 12, the control method 208 provides the set of input parameters 202, the set of offset input parameters 204, and the acknowledgement message 206 into a single contention parameters (CP) message 210. Such use of the contention parameters message 210 between a transmitting network device (e.g., initiator 20) and a receiving network device (e.g., responder 30) helps creates necessary offsets between transmission states and reception states of nodes 20, 30 prior to establishing a contention free schedule upon execution of the schedule program 150.

It should be understood that the control method 208 of control program 200 may be executed at other stages upon discovery between two nodes 20, 30. In one instance, control program 200 may be executed by initiator node 20 following the discovery operation with responder 30 as a standalone process or protocol. As such, the control program 200 may be executed prior to executing the scheduling program 150 but following the predictive contention program 50 once a set of default parameters have been established between the node 20, 30 during the discovery process. Further, it should also be understood that such control program 200 may operate one or more times when a link is established between the nodes 20, 30 for further optimization and/or maintenance of transmission and reception time intervals between the nodes 20, 30 based on various reasons, including the transmission and reception capabilities of each node 20, 30.

In one instance, the contention parameters message 210 may be included as a first step 212. As best seen in FIG. 13A, the first step 212 performed by initiator 20 sends a set of contention parameters (as the contention parameters message 210) to the responder 30. It should be understood that the contention parameters included in the message 210 are specific to transmission and reception capabilities of the initiator 20 to optimize the time of transmission and reception of the initiator 20. It should also be noted that initiator 20 also concurrently requests an acknowledgement that receiving node or responder 30 acknowledges such contention parameters of initiator 20.

Once the contention parameters message 210 is output from initiator 20, the responder 30 receives the contention parameter message 210 and performs a second step 214. As best seen in FIG. 13A, the second step 214 performed by responder 30 sends a set of contention parameters (as the contention parameters message 210) to the initiator 20 similar to the first step 212. It should be understood that the contention parameters included in the message 210 from responder 30 are specific to transmission and reception capabilities of the responder 30 to optimize the time of transmission and reception of the responder 30. It should be understood that the acknowledgement message is sent to the initiator 20 only to confirm that the contention parameters are established at a specific time between the initiator 20 and the responder 30 when a link is established between both nodes 20, 30. It should be understood that that if node 30 wanted to modify its contention parameters, node 30 would follow this method as initiator with node 20 being the responder.

In another instance, one or more parameters included in the contention parameters message 210 may be updated to populate an updated contention parameters message 216 (see FIG. 13B). In this instance, any parameter included in the set of input parameters 202 and any parameter included in the set of offset input parameters 204 may be updated and/or changed. In this same instance, an updated acknowledgment message 216A may also be populated based on the updated contention parameters message 216 so that the responder 30 may receive and accept the updated contention parameters message 216. Once the updated acknowledgement message 216A is sent back to the initiator 20 to confirm that the updated contention parameters are known by the responder 30, the updated contention parameters are then established and run by the initiator 20; such acknowledgement of receiving the updated acknowledgement message by the responder 30 is denoted by an arrow labeled 216B in FIG. 13B. If, however, the updated acknowledgement message 216A is not received by the responder 30 and/or the acknowledgement message 216A times out after a desired period of time, another updated contention parameters message 216 along with another updated acknowledgment message 216A may be sent to the responder 30. Similar to the set of maintenance instructions 164 mentioned above, the initiator 20 maintains the initial contention parameters sent under the contention parameters message 210 when the updated acknowledgement message 216 fails to be acknowledged and sent back to the initiator 20 by the responder 30.

In yet another instance, the initiator 20 may also access and execute a timeout traffic method 218 (as seen in FIG. 13C) subsequent to accessing and executing the initiation method 160 that includes the contention parameters message 210. Such timeout traffic method 218 may be accessed and executed by the initiator 20 when there is a lack of communication and/or traffic between the initiator 20 and the responder 30 for a predetermined period of time. If such predetermined period of time is met, the initiator 20 may initiate the timeout traffic method 218 by cancelling any future contention parameters or new contention parameters between the nodes 20, 30 and maintaining the parameters currently in force between nodes 20, 30. It should be noted that once the timeout traffic method 218 is complete, all communication between the initiator 20 and responder 30 is also dropped.

Having now described the control program 200 of the transmission system 1, a method of using the control program 200 in at least one example is discussed in greater detail below.

As best seen in FIG. 14A, a first node or initiator 20 (denoted “Node A”) and a second note or responder 30 (denoted “Node B”) are shown prior to being in communication with one another. It should be understood that the initiator 20 and the responder 30 may execute and run the predictive contention program 50 prior to executing the control program 200 to set the number of time intervals of the first set of time intervals 26 of the initiator 20 and the second set of time intervals 36 of the responder 30. If the predictive contention program 50 has been executed and established, the initiator 20 and the responder 30 may execute and run the control program 200 for setting the size of each time interval of the first set of time intervals 26 and the second set of time intervals 36 with desired transmission and reception offsets. For diagrammatic purposes, the initiator 20 is shown having a total of four time intervals of the first set of time intervals 26 where two time intervals are configured in the transmit state 26A and the remaining two time intervals are configured to the receive state. Similarly, the responder 30 is shown having a total of four time intervals of the second set of time intervals 36 where two time intervals are configured in the transmit state 36A and the remaining two time intervals are configured to the receive state 36B. In other exemplary embodiments, the initiator 20 and the responder 30 may have any suitable number of time intervals for transmission and reception purposes.

With respect to the two time intervals of first set of time intervals 26 set to the transmit state 26A, each time interval defines a minimum transmission size based on the minimum transmission size input 202C of the control program 200 and defines a maximum transmission size based on the maximum transmission variance input 202E of the control program 200; the minimum transmission size of each communication time interval 26 that is set to the transmit state 26A is denoted by double arrows labeled “TMIN1” in FIGS. 14A-14B, and the maximum transmission size of each communication time interval 26 that is set to the transmit state 26A is denoted by double arrows labeled “TMAX1” in FIGS. 14A-14B. Similarly, with respect to the two time intervals of first set of time intervals 26 set to the receive state 26B, each communication time interval defines a minimum reception size based on the minimum reception size input 202D of the control program 200 and defines a maximum reception size based on the maximum reception variance input 202F of the control program 200; the minimum reception size of each communication time interval 26 that is set to the receive state 26B is denoted by double arrows labeled “RMIN1” in FIGS. 14A-14B, and the maximum reception size of each time interval 26 that is set to the receive state 26B is denoted by double arrows labeled “RMAX1” in FIGS. 14A-14B.

With respect to the time intervals of the second set of time intervals 36 set to the transmit state 36A, each time interval defines a minimum transmission size based on the minimum transmission size input 202C of the control program 200 and defines a maximum transmission size based on the maximum transmission variance input 202E of the control program 200; the minimum transmission size of each communication time interval 36 that is set to the transmit state 36A is denoted by double arrows labeled “TMIN2” in FIGS. 14A-14B, and the maximum transmission size of each communication time interval 36 that is set to the transmit state 36A is denoted by double arrows labeled “TMAX2” in FIGS. 14A-14B. Similarly, with respect to the two time intervals of first set of time intervals 36 set to the receive state 36B, each time interval 36 that is set to the receive state 36B defines a minimum reception size based on the minimum reception size input 202D and defines a maximum reception size based on the maximum reception variance input 202F of the control program 200; the minimum reception size of each communication time interval 36 that is set to the receive state 36B is denoted by double arrows labeled “RMIN2” in FIGS. 14A-14B, and the maximum reception size of each time interval 36 that is set to the receive state 36B is denoted by double arrows labeled “RMAX2” in FIGS. 14A-14B.

In this example, the initiator 20 also sets desired offsets to each time interval 26 that is set to the transmit state 26A and to each time interval 26 that is set to the receive state 26B. As best seen in FIG. 14A, each transmission time interval defines a transmission start offset based on the transmission start offset input 204A of the control program 200 and defines a transmission end offset based on the transmission end offset input 204C of the control program 200; the transmission start offset of each time interval 26 that is set to the transmit state 26A is denoted by double arrows labeled “TOFFI1” in FIGS. 14A-14B, and the transmission end offset of each time interval 26 that is set to the transmit state 26A is denoted by double arrows labeled “TOFFI2” in FIGS. 14A-14B. Similarly, with respect to the time intervals of the first set of time intervals 26 that are set to the receive state 26B, each time interval 26 this is set to the receive state 26B defines a reception start offset based on the reception start offset input 204B of the control program 200 and defines a reception end offset based on the reception end offset input 204D of the control program 200; the reception start offset of each time interval 26 set to the receive state 26B is denoted by double arrows labeled “ROFFI1” in FIGS. 14A-14B, and the reception end offset of each time interval 26 set to the receive state 26B is denoted by double arrows labeled “ROFFI2” in FIGS. 14A-14B.

Similarly, the responder 30 also sets desired offsets for each time interval of the second set of time intervals 36 set to the transmit state 36A and each time interval of the second set of time intervals 36 set to the receive state 36B. As best seen in FIG. 14A, each time interval 36 that is set to the transmit state 36A defines a transmission start offset based on the transmission start offset input 204A of the control program 200 and defines a transmission end offset based on the transmission end offset input 204C of the control program 200; the transmission start offset of each time interval 36 that is set to the transmit state 36A is denoted by double arrows labeled “TOFFR1” in FIGS. 14A-14B, and the transmission end offset of each time interval 36 that is set to the transmit state 36A is denoted by double arrows labeled “TOFFR2” in FIGS. 14A-14B. Similarly, with respect to each time interval of the second set of time intervals 36 that is set to the receive state 36B, each time interval 36 set to the receive state 36B defines a reception start offset based on the reception start offset input 204B of the control program 200 and defines a reception end offset based on the reception end offset input 204D of the control program 200; the reception start offset of each time interval 36 that is set to the receive state 36B is denoted by double arrows labeled “ROFFR1” in FIGS. 14A-14B, and the reception end offset of each time interval 36 that is set to the receive state 36B is denoted by double arrows labeled “ROFFR2” in FIGS. 14A-14B.

Once the set of input parameters 202 and the set of offset input parameters 204 are defined, the initiator 20 and the responder 30 may then execute the schedule program 150 to establish a contention free schedule around the set of input parameters 202 and the set of offset input parameters 204. As best seen in FIG. 14B, a single communication opportunity is offered and accepted between the initiator 20 and the responder 30 to provide transmission from the time intervals 26 of the initiator 20 that are set to the transmit state 26A (see boxes labeled “TXOP B”) to the time intervals 36 of the responder 30 that are set to the receive state 36B (see boxes labeled “RXOP A”). As best seen in FIG. 14B, two communication opportunities are also offered and accepted between the initiator 20 and the responder 30 to provide transmission from the time intervals 36 of the responder 30 that are set to the transmit state 36A (see boxes labeled “TXOP A”) to the time intervals 26 of the initiator 20 that are set to the receive state 36B (see boxes labeled “RXOP B”).

It should be understood that while predictive contention program 50, scheduling program 150, and control program 200 are intended to operate separately and independently of one another, other exemplary embodiments are discussed below in which one or more of the programs 50, 150, 200 may be executed concurrently or simultaneously to establish a link between a pair of nodes.

In one instance, a computer program product may include predictive contention program 50 and control program 200. In this instance, control program 200 may be executed by a processor of each network device prior to establishing a communication schedule between one another. As such, the processor of each network device may establish desired time interval offsets at transmission states and at reception states based on various reasons discussed above. Additionally, predictive contention program 50 is also executed by the processor of each network device to establish a schedule for the respective network device that may be accessed by the other network device. It should be understood that known and/or conventional discovery operations are executed by the processors of the network devices prior to executing predictive contention program 50; however, control program 200 may be executed by the processors of the network devices as the discovery operation occurs.

In another instance, another computer program product may include predictive contention program 50 and the contention free schedule program 150. In this instance, contention free schedule program 150 may be executed by a processor of each network device prior to establishing a contention-free schedule between one another. As such, the processor of each network device may transmit and receive various transmission and reception opportunities between one another as discussed above. Additionally, predictive contention program 50 is also executed by the processor of each network device to establish a schedule for the respective network device that may be accessed by the other network device. It should be understood that known and/or conventional discovery operations are executed by the processors of the network devices prior to executing contention program 50; however, contention free schedule program 150 may be executed by the processors of the network devices as the discovery operation occurs while predictive contention program 50 runs in the background.

In yet another instance, another computer program product may include predictive contention program 50, contention free schedule program 150, and control program 200. In this instance, processors of network devices may run and/or execute one or more of these programs 50, 150, 200 dictated by the communication circumstances between the network devices. As such, processors of the network devices may select to execute and run a single program in order to establish a schedule between the network devices or may run at least two programs to establish a schedule between the network devices.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 100 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A computer program product including one or more non-transitory machine-readable mediums encoded with instructions that, when executed by one or more processors of a set of network devices of a transmission system, cause a process to establish a resolution schedule subsequent to a discovery operation, the instructions comprising:
execute, by a first processor of the at least two processors of an initiator of the set of network devices, a set of initiation instructions that instructs the initiator to output an initiation message including at least a set of initiator transmission opportunities having a first scope upon receiving a contention variable from a responder of the network device;
execute, by a second processor of the at least two processors of the responder of the set of network devices, a set of response instructions that instructs the responder to select a set of responder response opportunities upon receiving the set of initiator transmission opportunities and to output a response message that includes at least a set of responder transmission opportunities having a second scope; and
execute, by the first processor of the initiator, a set of confirmation instructions that instructs the initiator to select a set of initiator response opportunities upon receiving the set of responder transmission opportunities and to output a confirmation message that includes the set of initiator response opportunities.

2. The computer program product of claim 1, wherein the instructions further comprise:
execute, by the first processor of the initiator of the set of network devices, a set of first maintenance instructions that instructs the initiator to output a first maintenance message including a second set of initiator transmission opportunities having a third scope that is greater than the first scope; and
execute, by the second processor of the responder of the set of network devices, a set of second maintenance instructions that instructs the responder to select a second set of responder response opportunities upon receiving the second set of initiator transmission opportunities and to output a second maintenance message that includes a second set of responder transmission opportunities having a fourth scope that is greater than the second scope and is equal with or different than the third scope.

3. The computer program product of claim 1, wherein the instructions further comprise:
execute, by the first processor of the initiator of the set of network devices, a termination method that instructs the initiator to output a termination message to the responder to terminate communication between the initiator and the responder.

4. The computer program product of claim 1, wherein the instruction to execute the set of initiation instructions by the first processor of the initiator further comprises:
execute, by the first processor of the initiator of the set of network devices, a puncturing step that instructs the initiator to transmit a punctured message to the responder to provide communication between the initiator and the responder.

5. The computer program product of claim 4, wherein the instructions further comprise:
execute, by the second processor of the responder of the set of network devices, a termination step that instructs the responder to transmit a termination message to a preexisting network device to terminate communication between the responder and the preexisting network device at at least one response opportunities of the set of responder response opportunities.

6. The computer program product of claim 1, wherein the first scope and the second scope are different from one another.

7. The computer program product of claim 1, wherein the instructions further comprise:
execute, by the first processor of the initiator, at least one initiator back-off step that instructs the first processor of the initiator to refrain from selecting one or more transmission opportunities from the set of initiator transmission opportunities or one or more receive opportunities from the set of initiator response opportunities.

8. The computer program product of claim 1, wherein the instructions further comprise:
execute, by the second processor of the responder, at least one responder back-off step that instructs the second processor of the responder to refrain from selecting one or more transmission opportunities from the set of responder transmission opportunities or one or more receive opportunities from the set of responder response opportunities.

9. The computer program product of claim 1, wherein the instructions of the initiator to output the initiation message and the confirmation message further includes:
output the initiation message and the confirmation message in a first signal direction; and
wherein the step of the responder to output the response message further includes:
output the response message in a second signal direction;
wherein the initiator and the responder are directional antennas such that the first signal direction and the second signal direction are concentrated in a single direction.

10. The computer program product of claim 1, wherein the instructions to output the initiation message and the confirmation message by the initiator further includes:
output the initiation message and the confirmation message in a plurality of first signal directions; and
wherein the step to output the response message by the responder further includes:
output the response message in a second signal direction;
wherein each of the initiator and the responder is an omnidirectional antenna.

11. A method of establishing a contention free schedule in a transmission system, the method comprising the steps of:
installing a computer program product with a set of network devices of the transmission system, the transmission system comprises at least:
an initiator of the set of network devices of the transmission system having a first processor; and
a responder of the set of network devices of the transmission system having a second processor that is operatively in communication with the initiator;
wherein when the computer program product is executed by the first processor of the initiator and the second processor of the responder, the first processor and the second processor are caused to:
output an initiation message including at least a set of initiator transmission opportunities having a first scope upon receiving a contention variable from the responder of the set of network devices;
select a set of responder response opportunities upon receiving the set of initiator transmission opportunities and to output a response message that includes at least a set of responder transmission opportunities having a second scope that is equal with or different than the first scope;
select a set of initiator response opportunities upon receiving the set of responder transmission opportunities and to output a confirmation message that includes the set of initiator response opportunities; and
establish the contention free schedule in the transmission system between the initiator and the responder for communicating at predetermined time periods.

12. The method of claim 11, wherein when the computer program product is executed by the first processor of the initiator and the second processor of the responder, the first processor and the second processor are further caused to:
output a first maintenance message including a second set of initiator transmission opportunities having a third scope that is greater than the first scope; and
select a second set of responder response opportunities upon receiving the second set of initiator transmission opportunities and to output a second maintenance message that includes a second set of responder transmission opportunities having a fourth scope that is greater than the second scope and is equal with or different than the third scope.

13. The method of claim 11, wherein when the computer program product is executed by the first processor of the initiator and the second processor of the responder, the first processor and the second processor are further caused to:
output a termination message to the responder to terminate communication between the initiator and the responder.

14. The method of claim 11, wherein when the computer program product is executed by the first processor of the initiator and the second processor of the responder, the first processor is further caused to:
transmit a punctured message to the responder to provide communication between the initiator and the responder.

15. The method of claim 14, wherein when the computer program product is executed by the first processor of the initiator and the second processor of the responder, the second processor is further caused to:
transmit a termination message to a preexisting network device to terminate communication between the responder and the preexisting network device at at least one response opportunities of the set of responder response opportunities.

16. The method of claim 11, wherein when the computer program product is executed by the first processor of the initiator and the second processor of the responder, the first processor is further caused to:
refrain from selecting one or more transmission opportunities from the set of initiator transmission opportunities or one or more receive opportunities from the set of initiator response opportunities.

17. The method of claim 11, wherein when the computer program product is executed by the first processor of the initiator and the second processor of the responder, the second processor is further caused to:
refrain from selecting one or more transmission opportunities from the set of responder transmission opportunities or one or more receive opportunities from the set of responder response opportunities.

18. The method of claim 11, wherein the steps to output the initiation message and the confirmation message by the initiator further includes:
output the initiation message and the confirmation message in a first signal direction; and
wherein the step of the responder to output the response message by the responder further includes:
output the response message in a second signal direction;
wherein the initiator and the responder are directional antennas such that the first signal direction and the second signal direction are concentrated in a single direction.

19. The method of claim 11, wherein the steps to output the initiation message and the confirmation message by the initiator further includes:
output the initiation message and the confirmation message in a plurality of first signal directions; and
wherein the step of the responder to output the response message by the responder further includes:
output the response message in a second signal direction;
wherein the initiator and the responder are omnidirectional antennas.

20. A transmission system, comprising:
an initiator having a first processor and a first computer readable medium accessible by the first processor;
a responder having a second processor and a second computer readable medium accessible by the second processor, wherein the responder is operatively in communication with the initiator; and
a computer program product that is stored on the first computer readable medium and is stored on the second computer readable medium;
wherein when the computer program product is executed by the first processor of the initiator and the second processor of the responder, the computer program product establishes a contention free schedule between the initiator and the responder to communicate at predetermined time periods.

21. A method, comprising:
installing a computer program product with a set of network devices of a transmission system, wherein each network device of the set of network devices of the transmission system comprises at least:
a processor; and
a computer readable medium that is accessible by the processor and stores the computer program product having a predictive contention program and a control program;
wherein when the computer program product is executed by the processor of each network device of the set of network devices of the transmission system, each processor is caused to:
input a set of contention parameters for at least one set of communication time intervals;
input a set of offset parameters for the at least one set of communication time intervals;
select whether at least one set of communication time intervals is set to a transmission state or a reception state;
generate a number of communication time intervals that defines the at least one set of communication time intervals set at the transmission state or the reception state;
apply a time offset to each communication time interval of the at least one set of communication time intervals; and
generate a schedule with the at least one set of communication time intervals set at the transmission state or the reception state.

22. The method of claim 21, wherein when the selected communication time intervals are set to the transmission state, the computer program product further comprises:
select at least another set of communication time intervals for the reception state;
generate a number of communication time intervals that sets the at least another set of communication time intervals to the reception state; and
integrate the at least another set of communication time intervals set at the reception state into the schedule.

23. The method of claim 1, wherein when the selected communication time intervals are set to the reception state, the computer program product further comprises:
select at least another set of communication time intervals for the transmission state;
generate a number of communication time intervals that sets the at least another set of communication time intervals to the transmission state; and
integrate the at least another set of communication time intervals set at the transmission state into the schedule.

24. The method of claim 21, wherein when the processor of each network device inputs the set of contention parameters, the processor is further caused to:
input a minimum number of transmit time intervals; and
input a minimum number of reception time intervals.

25. The method of claim 24, wherein when the processor of each network device inputs the set of contention parameters, the processor is further caused to:
input a maximum variance allowed number of transmit time intervals; and
input a maximum variance allowed number of reception time intervals.

26. The method of claim 21, wherein when the processor of each network device inputs the set of contention parameters, the processor is further caused to:
generate a schedule size.

27. The method of claim 21, wherein when the processor of each network device inputs the set of contention parameters, the processor is further caused to:
generate a seed for an assigned period of time;
wherein the seed include at least a common key and a node identifier.

28. The method of claim 27, wherein when the processor of each network device inputs the set of contention parameters, the processor is further caused to:
set the seed.

29. The method of claim 21, wherein the step to input the set of offset parameters further comprises:
input transmission start offsets for the set of offset input parameters; and
input transmission end offsets for the set of offset input parameters.

30. The method of claim 21, wherein the step to input the set of offset parameters further comprises:
input reception start offsets for the set of offset input parameters; and
input reception end offsets for the set of offset input parameters.

31. A method, comprising:
installing a computer program product with a set of network devices of a transmission system, wherein each network device of the set of network devices of the transmission system comprises at least:
a processor; and
a computer readable medium that is accessible by the processor and stores the computer program product having a predictive contention program and a contention resolution program;
wherein when the computer program product is executed by the processor of each network device of the set of network devices of the transmission system, each processor is caused to:
generate a schedule with the at least one set of communication time intervals;
output an initiation message including at least a set of initiator transmission opportunities having a first scope upon receiving a contention variable from the responder of the set of network devices;
select a set of responder response opportunities upon receiving the set of initiator transmission opportunities and to output a response message that includes at least a set of responder transmission opportunities having a second scope that is equal with or different than the first scope;
select a set of initiator response opportunities upon receiving the set of responder transmission opportunities and to output a confirmation message that includes the set of initiator response opportunities; and
establish the contention free schedule between the initiator and the responder for communicating at predetermined time periods.

32. The method of claim 31, wherein when the computer program product is executed by the processor of each network device of the set of network devices of the transmission system, each processor is further caused to:
input a set of contention parameters for at least one set of communication time intervals;
select whether at least one set of communication time intervals is set to a transmission state or a reception state;
generate a number of communication time intervals that defines the at least one set of communication time intervals set at the transmission state or the reception state; and
generate a schedule with the at least one set of communication time intervals set at the transmission state or the reception state.

33. The method of claim 32, wherein when the selected communication time intervals are set to the transmission state, the computer program product further comprises:
select at least another set of communication time intervals for the reception state;
generate a number of communication time intervals that sets the at least another set of communication time intervals to the reception state; and
integrate the at least another set of communication time intervals set at the reception state into the schedule.

34. The method of claim 32, wherein when the selected communication time intervals are set to the reception state, the computer program product further comprises:
select at least another set of communication time intervals for the transmission state;
generate a number of communication time intervals that sets the at least another set of communication time intervals to the transmission state; and
integrate the at least another set of communication time intervals set at the transmission state into the schedule.

35. The method of claim 32, wherein when the processor of each network device inputs the set of contention parameters, the processor is further caused to:
input a minimum number of transmit time intervals;
input a minimum number of reception time intervals;
input a maximum variance allowed number of transmit time intervals; and
input a maximum variance allowed number of reception time intervals.

36. The method of claim 31, further comprising:
output a first maintenance message including a second set of initiator transmission opportunities having a third scope that is greater than the first scope; and
select a second set of responder response opportunities upon receiving the second set of initiator transmission opportunities and to output a second maintenance message that includes a second set of responder transmission opportunities having a fourth scope that is greater than the second scope and is equal with or different than the third scope.

37. The method of claim 31, further comprising:
output a termination message to the responder to terminate communication between the initiator and the responder.

38. The method of claim 31, further comprising:
output a punctured message to the responder to provide communication between the initiator and the responder.

39. The method of claim 31, further comprising:
output a termination message to a preexisting network device to terminate communication between the responder and the preexisting network device at at least one response opportunities of the set of responder response opportunities.

40. A transmission system having at least two network devices that are operable with one another, each network device of the at least two network devices comprising:
a processor a computer program product stored on a computer readable medium and executable by the processor of each of the initiator and the responder, the computer program product comprising:
a predictive contention program executable by the processor to generate a schedule with a first set of communication time intervals set at a transmit state and a second set of communication time intervals set at a receive state;
a contention resolution program executable by the processor to establish a contention free schedule between the at least two network devices of transmission system; and
a control program executable by the processor to offset at least one communication time interval.
